(19) United States
(12) Patent Application Publication
(10) Pub. No.: US 2009/0023607 A1
(43) Pub. Date: Jan. 22, 2009

(54) COMPACT NANOFABRICATION APPARATUS

(75) Inventors: Sergey V. Rozhok, Skokie, IL (US); Michael Nelson, Libertyville, IL (US); Nabil A. Amro, Chicago, IL (US); Joseph S. Fragala, San Jose, CA (US); Raymond Roger Shile, Los Gatos, CA (US); John Edward Bussan, Naperville, IL (US); Dirk N. vanMerkestyn, Beach Park, IL (US)

Correspondence Address: FOLEY AND LARDNER LLP;SUITE 500, 3000 K STREET NW, WASHINGTON, DC, 20007, US

(73) Assignee: Nanolnk, Inc.

(21) Appl. No.: 12/116,908

(22) Filed: May 7, 2008

Related U.S. Application Data
(60) Provisional application No. 60/916,979, filed on May 9, 2007.

(51) Int. Cl. C40B 50/14; C40B 60/14

(52) U.S. Cl. 506/30; 506/40

(57) ABSTRACT

An apparatus for use in fabricating structures and depositing materials from tips to surfaces for patterning in direct-write mode, providing ability to travel macroscopic distances and yet provide for nanoscale patterning. Useful in small scale fabrication and nanolithography. The instrument can be compact and used on a laboratory bench or desktop. An apparatus comprising: at least one multi-axis assembly comprising a plurality of nanopositioning stages, at least one pen assembly, wherein the pen assembly and the multi-axis assembly are adapted for delivery of material from the pen assembly to a substrate which is positioned by the multi-axis assembly, at least one viewing assembly, at least one controller. Nanopositioning by piezoelectric methods and devices and motors is particularly useful. The apparatus can include integrated environmental chambers and housings, as well as ink reservoirs for materials to be delivered. The viewing assembly can be a microscope with a long working distance. Particularly useful for fabrication of bioarrays or microarrays. The multi-axis assembly can be a five-axis assembly. Software can facilitate efficient usage.

### RELATED APPLICATIONS

This application claims priority to U.S. provisional application Ser. No. 60/916,979 filed May 9, 2007, which is hereby incorporated by reference in its entirety.

### FEDERAL FUNDING

The claimed inventions described herein were developed with use of NIH SBIR grant no. 2 R44 HG002978-02. The government has certain rights in the claimed inventions.

### BACKGROUND

Many applications in a modern economy require the use of building and imaging structures at smaller and smaller scale including the nanoscale (e.g., nanofabrication). For example, smaller and more sophisticated electronic circuits and components are needed. In addition, smaller and more sophisticated biological structures and arrays are needed. Complex repair processes are needed at small scale. In working at smaller scales, better alignment and higher resolution methods are needed. One important method is direct-write lithography, or direct-write nanolithography, wherein drawing or patterning is done directly on a structure. One approach to do this is tip-based, wherein a material is coated onto a sharp tip (e.g., a SPM or AFM tip) and then delivered from a sharp tip to a surface. See for example U.S. Pat. Nos. 6,635,311 and 6,827,979 to Mirkin et al. See also NSCRIPTOR™ nanolithography instrumentation sold by NanoInk (Skokie, Ill.). Nanoscale fabrication, however, presents many difficulties and uncertainties which may not arise at larger scales.

One important need when building at the small scale, including the nanoscale, is the ability to operate over longer macroscale distances without stopping the building process at the nanoscale and losing registration. In other words, nanoscale fabrication can also involve moving over macroscales (e.g., mm's). Many apparatuses and instruments do not provide this capability. For example, if one is depositing material in a line, one wants to be able to deposit long lines. Or if one is depositing material in an array of dots or spots, one wants to have a wide and/or long array in some cases. Moreover, a need exists to simplify apparatuses and instruments capable of doing these operations. A need also exists for these instruments to be versatile and provide sensitivity and reliability. It also helps if instruments are compact and small. One aspect of versatility is ability to function with many types of delivery devices including for example one dimensional arrays of delivery devices as well as two dimensional delivery devices, which may cause different and more difficult alignment problems. In a two-dimensional array, the plane of the array and the plane of the surface should be matched, which is difficult to do at a nanoscale. Moreover, the angle between a nanoscopic tip and a surface should be carefully controlled.

In particular, a need exists to develop better manufacturing methods for making bioarrays including protein and peptide arrays and DNA and oligonucleotide arrays. Current methods include, for example, in-situ synthesis (e.g., Affymetrix), microcontact printing (e.g., Nano-terra), and robotic spotting methods.

U.S. Pat. No. 6,827,979 describes delivery of ink material from sharp tips to a substrate surface, wherein the substrate surface can be tilted to selectively engage the tips.

PCT publication WO 2006/076302 describes a surface patterning system. However, this system does not provide for among other things tilting of a substrate surface to be patterned. See also for example U.S. Pat. No. 7,008,769.

Nanolithographic deposition instruments are known in which material is delivered from a pen array to a substrate, wherein the pen array is controlled by three axis positioning.

### SUMMARY

Provided herein are, for example, articles, instruments, apparatuses, kits, methods of making, methods of using, and software and hardware.

For example, one embodiment provides an apparatus comprising: at least one multi-axis assembly comprising at least five nanopositioning stages, at least one pen assembly, wherein the pen assembly and the multi-axis assembly are adapted for delivery of material from the pen assembly to a substrate which is positioned by the multi-axis assembly, at least one viewing assembly, at least one controller.

Another embodiment provides an apparatus comprising: at least one multi-axis assembly comprising at least one piezoelectric nanopositioning X stage, at least one piezoelectric nanopositioning Y stage, at least one piezoelectric nanopositioning Z stage, a first piezoelectric goniometer to provide tilt, and a second piezoelectric goniometer to provide tilt orthogonal to that of the first goniometer, at least one pen assembly comprising an array of pens, wherein the pens comprise an array of cantilevers, and the cantilevers have tips disposed thereon, wherein the pen assembly and the multi-axis assembly are adapted for delivery of material from the tips of the pen assembly to a substrate which is positioned by the multi-axis assembly, wherein the multi-axis assembly is adapted to be coupled with an environmental chamber to surround the pen assembly and substrate and is also adapted to function with a removable table assembly on which the substrate is disposed, at least one viewing assembly, at least one controller.

Another embodiment provides a method comprising: providing an array of pens comprising cantilevers, wherein the cantilevers comprise tips, disposing material on the tips, delivering material from the tips to a substrate, wherein the spatial position and orientation of the substrate is controlled by a multi-axis assembly providing motion in the X direction, the Y direction, the Z direction, a first tilt, and a second tilt orthogonal to the first tilt.

Another embodiment provides an apparatus comprising: at least one five-axis assembly comprising at least five integrated piezoelectric nanopositioning stages, at least one pen assembly, wherein the pen assembly and the multi-axis assembly are adapted for delivery of material from the pen assembly to a substrate which is positioned by the five-axis assembly, at least one viewing assembly, and at least one controller, wherein the five-axis assembly comprises five independent stages including at least one X-stage, at least one Y-stage, at least one Z-stage, a first tilt stage, and a second tilt stage which provides tilt orthogonal to the tilt of the first tilt stage.

Another embodiment provides a method comprising: providing an apparatus according to embodiments described herein, delivering material from the pen assembly to the substrate.

Still further, another embodiment is an apparatus comprising: at least one multi-axis assembly comprising at least five nanopositioning stages, wherein the multi-axis assembly comprises five independent stages including at least one X-stage, at least one Y-stage, at least one Z-stage, a first tilt stage, and a second tilt stage which provides tilt orthogonal to the tilt of the first tilt stage.

Software can be adapted to execute the methods described and claimed herein.

One or more advantages which can be found in one or more of the various embodiments described herein include ability to operate at a macroscale (e.g., macroscale pen travel) with retention of nanoscale resolution and registration, good sensitivity, good reliability, less expensive, good versatility, ability to use a wide variety of deposition materials of use in both biotechnology and electronics applications, and compactness (e.g., ability to use on desktop). In particular, sub-micron arrays can be generated with the instrument over millimeter-scale areas with nanometer resolution to create, for example, nucleic acid and protein assemblies on, for example, metal or glass surfaces. Nanoscale patterning of antibodies and oligomers, as well as screening their biological activity, can be achieved with excellent uniformity and repeatability of features within and between the arrays. The process can require significantly smaller amounts of synthesis and labeling materials, which is pertinent to, for example, investigating drug targets that are expressed in vanishingly small quantitities. Provided is programmable multiplexed deposition over macro-scale area with nm resolution.

### BRIEF DESCRIPTION OF THE FIGURES

FIG. 1 illustrates a working embodiment of an instrument showing (a) a first side view, (b) a second side view, and (c) a perspective view.

FIG. 2 illustrates a working embodiment showing an exploded view of a microscope assembly including mount.

FIG. 3 illustrates a working embodiment showing a pen array and supporting assembly.

FIG. 4 illustrates a working embodiment showing an exploded view of a rotational table assembly.

FIG. 5 illustrates a working embodiment showing an exploded view of an enclosure.

FIG. 6 illustrates a working embodiment showing an environmental chamber added to the instrument.

FIG. 7 illustrates a working embodiment showing a stage 1 at lowest position (a) first side view, (b) second side view.

FIG. 8 illustrates a working embodiment showing a stage 1 at a middle position (a) first side view, (b) second side view.

FIG. 9 illustrates a working embodiment showing a stage 1 at a highest position (a) first side view, (b) second side view.

FIG. 10 illustrates a working embodiment showing a stage 1 at a highest position and a stage 2 at a five degree tilt, (a) first side view, (b) second side view.

FIG. 11 illustrates a working embodiment showing a stage 1 at a highest position and a stage 2 and a stage 3 both at a five degree tilt, (a) first side view, (b) second side view.

FIG. 12 illustrates a working embodiment showing a stage 1 at a highest position and a stage 2 and a stage 3 both at a five degree tilt, and a stage 4 translated 20 mm (a) first side view, (b) second side view.

FIG. 13 illustrates a working embodiment showing a stage 1 at a highest position and a stage 2 and a stage 3 both at a five degree tilt, and a stage 4 and a stage 5 both translated 20 mm (a) first side view, (b) second side view.

FIG. 14 illustrates a working embodiment showing a top view of top plate at most extreme position.

FIG. 15 illustrates a working embodiment showing a top view of top plate at lowest position.

FIG. 16 illustrates a microscope mount design.

FIG. 17 illustrates a working embodiment for an ACS controller and AB2 driver box front panel.

FIG. 18 illustrates an encoder.

FIG. 19 illustrates a working embodiment for an encoder.

FIG. 20 illustrates an engineering drawing for a nanoarray assembly.

FIG. 21 illustrates an engineering drawing for a plate for use in mounting a microscope.

FIG. 22 illustrates an engineering drawing for a plate for use in a bottom enclosure.

FIG. 23 illustrates an engineering drawing for a plate for use in a top enclosure.

FIG. 24 illustrates an engineering drawing for a block for use in a pen base.

FIG. 25 illustrates an engineering drawing for a plate for use in a pen base.

FIG. 26 illustrates an engineering drawing for a disc for use in a pen holder.

FIG. 27 illustrates an engineering drawing for a lever for use in a pen holder.

FIG. 28 illustrates an engineering drawing for a plate for use in a pen holder.

FIG. 29 illustrates an engineering drawing for a base for use in an adapter.

FIG. 30 illustrates an engineering drawing for a top piece for use in an adapter.

FIG. 31 illustrates another engineering drawing for a top piece for use in an adapter.

FIG. 32 illustrates an engineering drawing for a base.

FIG. 33 illustrates an engineering drawing for a cover for a rear enclosure.

FIG. 34 illustrates an engineering drawing for a cover for a front enclosure.

FIG. 35 shows a photograph of the larger instrument or apparatus.

FIG. 36 shows a photograph focusing on the multi-axis assembly.

FIG. 37 shows a photograph focusing on the microscope and environmental chamber.

FIG. 38 shows a photograph focusing on the microscope and environmental chamber from a top view.

FIG. 39 shows a photograph focusing on the microscope without the environmental chamber and showing pen holder and substrate.

FIG. 40 is similar to FIG. 39 but shows a side view.

FIG. 41 shows an environmental chamber removed from the instrument.

FIG. 42 shows instrument wiring.

FIG. 43 shows a perspective view of the instrument.

FIG. 44 shows a perspective view of the instrument.

FIG. 45 shows inserting the environmental chamber onto the instrument.

FIG. 46 shows inserting the environmental chamber onto the instrument.

### DETAILED DESCRIPTION

### Introduction

All references cited herein are incorporated by reference in their entirety.

To practice the presently claimed embodiments, one skilled in the art can use as needed, for example:

(i) Fundamentals of Microfabrication, The Science of Miniaturization, 2^{nd} Ed., Madou,

(ii) The Nanopositioning Book. Moving and Measuring to Better than a Nanometre, T. R. Hicks et al, 2000;

For example, use of piezoelectric effects in microfabrication and MEMS is known. See for example Madou at pages 551-560.

### Apparatus

Various important elements are described below. One skilled in the art can utilize these elements using known hardware, software, controller, mountings, cables, enclosures, electrical wiring, power supplies, and the like. In some cases, elements can be obtained as part of the materials and components obtained from vendors and distributors.

The apparatus can be an instrument or a component to an instrument.

A part can be a single part or a plurality of components fabricated together to function as a single part. An assembly can be a plurality of components fabricated together to function as a single assembly.

### Multi-axis Assembly

Three-axis, five-axis, and six-axis assemblies are known in the art. The apparatus can comprise at least one multi-axis assembly which can provide at least five modes of motion control via stages. The multi-axis assembly can be a five-axis assembly. The five stages can be integrated but can be independent stages and function independently.

Three axes can be the X, Y, and Z motions or directions known in the art. For example, the X and Y motions can provide lateral or linear motion in a plane in two orthogonal directions respectively via an X and Y stage, respectively. The Z motion, via a Z stage, can provide height raising and lowering with respect to the plane for the X and Y motions. In other words, a perpendicular motion can be provided by a Z stage.

Additional motions can provide for tilt in two orthogonal directions. For example, the plane can be tilted by rotation around an X axis, or rotation around a Y axis.

The five or more stages can be integrated into a single functioning unit, subject to control by one controller.

If desired, one or more additional stages can be provided and integrated to provide six or more stages. For example, a rotational stage can be added as a sixth stage of the multi-axis assembly.

Positioning systems and stages are known in the art including nanopositioning systems and stages and piezoelectric nanopositioning stages. See for example products by Linos, Goettingen, Germany. These include for example manual positioners including for example linear stages, XY stages, goniometer stages, rotary stages, vertical translation stages, tilting stages, prism stages, LUMINOS nanopositioners, and actuating drive, measuring and micrometer screws. These also include for example motorized positioners including for example linear stages, XY stages, rotary stages, and accessories. These also include controllers. These also include piezo systems including piezo positioners and piezo controllers.

A nanopositioning stage can displace objects at a nanometer range.

Various methods of actuation and motion can be used including for example piezoelectric, electrostatic, electromagnetic, and magnetostrictive.

Piezoelectric nanopositioning stages can comprise precision motors, including piezoelectric motors, for motion control as known in the art. See for example products and patents from Nanomotion Ltd (Yokneam, Israel). See for example U.S. Pat. Nos. 7,211,929; 7,199,507; 7,183,690; 7,119,477; 7,075,211; 7,061,158; 6,979,936; 6,879,085; 6,747,391; 6,661,153; 6,617,759; 6,473,269; 6,384,515; 6,367,289; 6,247,338; 6,244,076; 6,193,199; 6,064,140 to Nanomotion. U.S. Pat. No. 5,696,421 to Nanomotion describes multi-axis a rotation device including orthogonal axes. Piezoelectric micromotors are described in for example U.S. Pat. No. 5,616,980.

See also Friend et al., IEEE Transactions on Ultrasonics, Ferroelectrics, and Frequency Control, 53, 6, June 2006, 1160-1168.

Examples of electromagnetic include for example U.S. Pat. No. 7,185,590. Electromagnetic components and positioners can be obtained from for example Physik Instrumente. Examples of magnetostrictive include for example components available from Micromega Dynamics.

One skilled in the art can search vendors for nanopositioning technology, devices, and components.

The multi-axis assembly can comprise a component such as a motor or a stage adapted for linear X motion. For example, it can provide at least 10 mm, or at least 20 mm, or at least 40 mm of motion.

The multi-axis assembly can comprise a component such as a motor or a stage adapted for linear Y motion. For example, it can provide at least about 10 mm, or at least about 20 mm, or at least about 40 mm of motion. A range can be for example about 10 mm to about 60 mm.

The multi-axis assembly can comprise a component such as a motor or a stage adapted for linear Z motion. For example, it can provide at least 10 mm, or at least 20 mm, or at least 40 mm of motion. A range can be for example about 10 mm to about 60 mm.

The range of motion in the X and Y plane can provide for example at least about 400 square mm, or at least about 900 square mm, or at least about 1,600 square mm of coverage.

In some cases, a greater range of motion can be needed for the X motion and the Y motion, compared to the Z motion. For example, range for Z motion may be approximately 33% to 67% of the X motion range or Y motion range.

The multi-axis assembly can comprise a component such as a motor or a stage or a goniometer adapted for a first tilting motion. For example, a tilt angle can be for example at least 2 degrees, or at least five degrees, or at least 10 degrees.

The multi-axis assembly can comprise a component such as a motor or a stage or a goniometer adapted for a second tilting motion. This can function independently of the first tilt. For example, a tilt angle can be for example at least 2 degrees, or at least five degrees, or at least 10 degrees.

The tilting motions can provide alignment between the plane surface of the substrate and the plane surface of the pen assembly. Moreover, the tilting motions can allow for better coating of material onto tips from a substrate, or better delivery or deposition of materials from the tip to the substrate. The angle between the tip and the substrate can be better controlled with multi-axis tilting. For example, tilt angles of about 7 degrees to about 15 degrees can be used as known in the art.

In particular, piezoelectric components and motors can be used effectively.

The multi-axis assembly can comprise one or more encoders including for example optical encoders, which are integrated with other elements including motors.

The multi-axis assembly can comprise multi-channel controllers and amplifiers to drive piezomotors.

The stages can have a resolution of 5 nm and a repeatability of ±15 nm or even more preferably ±5 nm. Operation travel speed can be for example at least 100 nm/sec or at most 20 cm/sec and a range can be for example about 100 nm/sec to about 20 cm/sec.

All five stages can be integrated into the multi-axis assembly and controlled from a single multi-channel controller. This design can isolate the precision mechanics from other parts of the system and can protect stages from operation under specific conditions such as high humidity or temperature, which might be applied during a fabrication process. Integrating all five stages can provide more room and flexibility for positioning components including for example pens, inkwells, dispersing system, environmental chamber, and optics. The multi-channel controller can be designed for parallel and independent operation of the stages and it supports reading, processing, and adjusting the position of each stage through its own logical processor.

The multi-axis assembly can be isolated from the working environment by an expandable screen.

The individual stages can comprise metals such as aluminum or steel.

In one embodiment, a piezo-tube actuator can be integrated with the stages. It can be installed on the uppermost stage.

The stages can be tuned, particularly when non-linear processes are used to drive processes are present as in many piezoelectric motors. Stage performance can depend on parameters such as for example speed of translation, travel range, and stage load. Users can optimize PID parameters (proportional-integral-derivative) for short-range and long-range motions for each stage of the assembly. Users can determine the correct PIDs and specify them in, for example, motion management software.

The multiple stages can be integrated so that they function together. For example, they can be placed on each other, including for example to make a vertical stack. For example, in one embodiment, the multi-axis assembly can be assembled so that the lowest stage is the Z stage; disposed on the Z stage is a first tilt stage; disposed on the first tilt stage is a second tilt stage; disposed on the second tilt stage is an X stage; and disposed on the X stage is a Y stage. The Z axis stage can be at the bottom and bear weight of other stages. One skilled in the art can integrate the different stages to function together and independently. For example, the maker of or vendor for a particular nanopositioning device can engineer how to integrate that particular nanopositioning stage with other nanopositioning stages to satisfy the specifications needed.

The multi-axis assembly can be supported by an XY coarse translation stage. This can be manually operated. It can provide, for example, a 50 mm×50 mm view over the entire substrate area. The coarse translation stage can be relatively large and can have, for example, a base of at least 10 cm, or at least 20 cm. Resolution can be for example down to at least one micron. Coarse translations stages can be obtained via, for example, Linos, Goettingen, Germany. Examples include the X-Y Stages XY 200 with Digital Micrometer.

In addition, software can be integrated to control and/or tune the motions of the stages with nanometer resolution.

Working examples for the multi-axis assembly are described further below.

### Enclosure/Controller/and Wiring for Multi-Axis Assembly

The multi-axis assembly can be disposed in an enclosure or housing. This can protect the precision mechanics from particulates, including dust. This can also separate the environment around the pen assembly and substrate from the environment of the multi-axis assembly. The enclosure can be made of for example any solid structural element including metal or polymer (including plastic) or ceramic. The enclosure can be adapted to not move despite motion of the multi-axis assembly. The enclosure can comprise a series of parts which function together, e.g., plates, including for example a top plate, a bottom plate, and one or more side plates. Supporting structures like rods can be used.

The top plate can have an opening. The opening can be adapted to function with and be sealed by the table assembly when the table assembly is in, for example, a lower position. The multi-axis assembly and the table assembly can be adapted so that there is physical separation and/or barrier between the environment of the enclosure and the environment of the environmental chamber. This can also keep out dust and debris from the multi-axis assembly. The opening can be also sealed by for example a webbing of material secured to the table assembly and the top housing plate. Alternatively, a circular brush seal can be used. A plate can be used to allow the table assembly to move freely while being held flat to the bottom of the top housing plate. Hence, when the table assembly moves, so does the plate while still covering the opening. Discs can be used including combinations of metal and plastic discs.

The wiring of the multi-axis assembly can be carried out with use of cables. For example, ten cables can be used, wherein for example five are for the motors and five are for the encoders.

The controller and amplifiers can be adapted by methods known in the art and information supplied by vendors. Cables and wires can be used as known in the art. The size, flexibility, exit point, and length can be adapted for a particular application.

Working examples for the enclosure, controller, and wiring are described further below.

### Table Assembly/Removable Substrate

The apparatus and multi-axis assembly can further comprise a table assembly, which can function as or be coupled with a sample holder or substrate holder. The table assembly can be adapted to hold and position a wide variety of substrates with different sizes and shapes. For example, the table assembly can be adapted to accept common commercial substrates up to for example 5 inches or up to 12 inches in length or diameter. The table assembly can be rotated and if desired locked into an arbitrary or chosen position.

The table assembly and substrate holder can be exchangeable. The table assembly and substrate holder can be adapted for temperature adjustment and control. For example, it can be equipped with a heater or cooler. The table assembly and substrate holder can be moved and positioned to be aligned with the X and Y axes of the positioner.

A removable substrate can be controlled by the multi-axis assembly. The substrate can be flat. The substrate can be adapted to couple with and be positioned by the multi-axis assembly. The substrate can be moved in the X-direction, the Y-direction, and the z-direction, as well as tilted in any of the two orthogonal tilt modes.

The substrate can be large enough to provide for macroscale positioning. Substrates can be metal, ceramic, polymer, glass, composite, blend, or any other solid material. The substrate can be surface treated. For example, a thin layer or layers or a monolayer can be disposed on the substrate surface. An example is a 1 inch×3 inch slide such as a glass slide. The glass slide can be treated.

A working example of a table assembly is further described below.

### Viewing Assembly/Microscope

The apparatus can comprise a viewing assembly such as for example a microscope, including an optical microscope or a combination of an optical and fluorescent microscope. For fluorescence, an IR laser can be included. This can be used for visual monitoring of fabrication processes, including positioning and alignment and making sure spotting has occurred. The optics can be characterized by high resolution and long working distance. For example, a working distance (e.g., distance between objective lens and sample surface) of at least about 20 mm or at least about 30 mm can be used, or about 30 mm to about 40 mm (e.g., 34 mm). An integrated zoom function can be used to adjust the field-of-view from for example about 2.1×2.8 mm to about 0.21×0.28 mm. These zoom values can depend on the microscope specifications. The focus and zooming functions can be motorized and can be accessed from a remote controller or through computer software. The resolution can be such to allow visualization of objects down to, for example, about 400 nm.

The images can be captured by video cameras and recorders and the like.

A microscope such as for example an A-Zoom2 10× Series analytical microscope (10:1 zoom range) can be obtained for example from Qioptiq Imaging Solutions, Rochester, N.Y. Optem® objectives can be used.

A working example of the viewing assembly is described further below.

An important feature is the ability for detection of submicron features. For example, dots can be generated over an array with dot diameter which decreases to less than one micron, but the dot can be detected with gray value measurements as a function of distance over the array. Detection can be achieve by, for example, fluorescent microscopy. Detection can also follow hybridization of arrays including submicron arrays.

### Pen Assembly & Delivery

The pen assembly can be adapted to deliver material from a tip to a substrate. The tip can be disposed on a cantilever. For example, a single tip can be used. Or a plurality of tips can be used. The tips can be disposed on an array of cantilevers, wherein each cantilever comprises one tip. For example, a one dimensional array of tips can be used. Alternatively, a two dimensional array of tips can be used. See for example U.S. patent application Ser. No. 11/690,738 and U.S. provisional application no. 60/894,657. A two dimensional array can comprise for example between about 10,000 pens to about 100,000 pens, such as about 55,000 pens. In one embodiment, a two dimensional 10×10 pen array can be built and integrated with the rest of the instrument for, for example, high-throughput printing DNA and proteins.

MEMS fabrication methods can be used to prepare pen assemblies including photolithography and electron beam lithography methods.

In particular, a nanoscale, sharp tip can be disposed on a cantilever including at the end of a cantilever. Tips can be nanoscale tips including for example scanning probe microscope tips including atomic force microscope tips. Tips can be solid or can be solid but have an opening, channel, or aperture.

Tips can be made of hard inorganic materials, e.g., SiN, silicon, or can be made of softer organic materials or can comprise coatings of harder or softer materials. Tips can be adapted for delivery of materials. For example, tips can be longer than normally made for mere imaging. Tips can be curved. Tips can be adapted to hold more material for delivery. Tips can be adapted to hold more viscous materials like materials comprising polymers or DNA or protein. Tips can also as needed be adapted for imaging such as AFM imaging.

The pen assembly can be adapted to be stationary or movable. In particular, it can be adapted to be movable in an X direction, a Y direction, or a Z direction. Or it can be adapted to be movable in only the Z direction. Here, the X direction and Y direction substantially are with respect to the plane of the substrate, whereas the Z direction is perpendicular to this plane.

The pen assembly can be moved and positioned to be aligned with the X and Y axes of the positioner. The pen assembly can be adapted to fit into an unmovable bracket. The bracket can be adapted as needed to comprise and hold items such as microchips or preamplifiers within a few centimeters of the pens.

Methods and devices and instruments are known in the art for delivering or depositing material from a tip or a pen to the substrate including at the nanoscale. See for example U.S. Pat. Nos. 6,635,311 and 6,827,979 to Mirkin et al (DPN® printing or DIP PEN NANOLITHOGRAPHY® printing). See also for example US Patent Publication 2005/0266149 to Henderson et al. The materials delivered can be for example organic, inorganic, or biological materials. Direct-write methods can be used. See for example Direct-Write Technologies for Rapid Prototyping Applications, Sensors, Electronics, and Integrated Power Sources, Ed. Pique, Chrisey, 2002, including for example chapters 10 and 18. Actuated tips are known. See for example U.S. Pat. No. 6,642,129 to Liu et al. Biological materials can be deposited including nucleic acid and protein or peptide materials. See for example US Patent Publication 2003/0068446 and PCT publication WO/2003/048314. Inks can be based on DMF solutions of DNA. Sol gel materials can be deposited. See for example US patent publication 2003/0162004. Polymers and conducting polymers can be delivered. See for example US Patent Publication 2004/0008330 and U.S. Pat. No. 7,102,656. Thermal delivery methods can be used. See for example US patent publication 2006/0040057. Catalyst materials can be delivered. See for example 2004/0101469 and U.S. Pat. No. 7,098,056. Conductive materials and precursors thereof can be delivered. See for example 2004/0127025 and U.S. Pat. No. 7,005,378. Magnetic materials can be delivered. See for example 2004/0142106. Monomers can be delivered. See for example 2005/0272885.

The materials deposited on the surface can adsorb to, chemisorb to, covalently bond to, or ionically bond to the surface. In many cases, a stable deposition is desired.

One embodiment comprises delivery of compounds which form self-assembled monolayers, such as sulfur compounds like thiols and sulfides deposited on gold.

One embodiment comprises deposition of antibodies, enzymes, and many other types of proteinaceous or peptide compounds or materials.

One embodiment comprises deposition of RNA, DNA, nucleic acids, oligonucleotides, and any other information containing monomer or polymer found in RNA and DNA.

Nanomaterials can be deposited including nanoparticles, nanorods, nanowires, nanotubes, fullerenes, dendrimers, and the like.

Material can be deposited, delivered, or patterned, and is then used to adsorb or bind to additional materials, including for example proteins or nanowires or other small particles. See for example U.S. Pat. No. 7,182,996.

The material deposited on the substrate can be liquid, wet, dry, or solid. Femtoliter amounts of inks can be deposited. Surfactants can be used. See for example, US Patent Publication 2006/0242740.

Humidity, temperature, and other parameters can be adapted so that a meniscus is formed between tip and substrate. Capillary forces and wetting interactions can be controlled.

Alignment can be controlled by computer software. See for example 2003/0185967. Calibration can be controlled by computer software. See for example U.S. Pat. No. 7,060,977.

Layered structures can be fabricated, and the height of structures can be increased with multiple depositions. One layer can be deposited. Another layer can be deposited thereon.

Structures can be random or regular, continuous or discontinuous, dots or lines, straight lines or curves lines, and the like.

Tips can be modified as desired. For example, tips can be coated with polymer if desired. See for example 2005/0255237.

In one embodiment, laser optics can be used for positioning and feedback. However, in another embodiment, the laser optics can be eliminated. For example, if the pen is adapted with sensors, then laser optics can be eliminated. This can simplify the device and allow for faster operation.

Structures can be formed which are nanometer in scale and separated by nm ranges. These can be nanostructures. Lateral dimension can be for example a line width or a dot diameter. For example, lateral dimension can be about 5 microns or less, or about 1,000 nm or less, or about 500 nm or less, or about 250 nm or less, or about 100 nm or less. Lateral dimension can be for example at least about 1 nm, or at least about 10 nm, or at least about 25 nm. Structures can be separated by distances or average distances of for example about 5 microns or less, or about 1,000 nm or less, or about 500 nm or less, or about 250 nm or less, or about 100 nm or less. This separation distance can be an edge to edge distance or a center to center distance.

Patterning can be done by delivery of different types of inks or materials. For example, at least two different materials, or at least twelve different materials, can be delivered onto a single substrate.

WO 2006/076302 (BioForce Nanosciences) describes surface patterning tools and piezoelectric motion assemblies.

Working examples of pen assemblies are described further below.

### Environmental Chamber

The apparatus can further comprise an environmental chamber. Environmental conditions can be controlled therein so they are independent of the surrounding air using a chamber that seals a volume between the multi-axis assembly (which may be enclosed) and the optical microscope. The environmental chamber can be adapted to enclose the pen assembly and substrate. The chamber can be transparent. It can be a plastic or glass for example. Because the chamber is relatively small, parameters such as temperature, humidity, and gas composition can be easily controlled. The chamber can be adapted for incoming air or gas streams and outlets for temperature and humidity sensors. In particular, these parameters can be controlled to control the delivery or deposition of material from tip to substrate. The environmental chamber can also be integrated with software to provide automatic feedback control. The environmental chamber can be equipped with electronic temperature and humidity sensors to provide automatic feedback control.

The working examples below further describe an example of an environmental chamber.

### Additional Parameters, Hardware, and Software

Methods and devices known in the art can be used to protect the instrument or apparatus from vibration. For example, the apparatus can be disposed, placed, and used on an air table.

Frames can be built and integrated with the rest of the instrument to mount two dimensional pen arrays and facilitate in plane (2D) alignment.

In addition, a system can be built and integrated to rotate pen arrays with respect to sample structures with, for example, 0.001 degree resolution.

Software can be used to manage delivery of material from pen assembly to substrate as known in the art. See for example products from NanoInk, Skokie, Ill. and U.S. Pat. No. 6,827,979.

Known computer hardware or instrument hardware in general can be integrated with software and functioning as controller. For example, a laser-based feedback system can be combined with software, or function independently of the software, as controller to provide automated operation, including approach, alignment, inking, and printing, and to improve quality of printing.

In some embodiments, atomic resolution scanners can be added to the instrument to provide independent imaging modality with sub-nanometer spatial resolution and/or registration. These scanners and the tips in the assembly used for inking and writing, can together provide simultaneous patterning and imaging of nanoscale features.

Kits can be used. For example, these can comprise accessories such as for example substrates, ink materials, pens, instructions, containers, inkwells, and the like.

Examples of instrument features which can be controlled by software include:
1. execution of stage routines from a motion control panel;
2. allow incremental and continuous motions;
3. allow low and high speed motions;
4. enable/disable stages;
5. specifiy and execute target positions;
6. monitor current positions for all stages;
7. execute stage routines for all stages simultaneously;
8. capture, save, and execute selected positions;
9. run routine to define top surface of print substrate that allows automatic approach and print capabilities;
10. calculate approach positions within printing region;
11. allows aligning for one dimensional and two dimensional pen arrays;
12. capture, save, and execute inking positions;
13. specify limits for safe moves;
14. approach and withdraw pens from motion control panel and through a pattern configuration code;
15. save and open experimental settings;
16. specify pattern configuration and print parameters (such as number, spacing, speed, length, and dwell time, for example) for individual dots and lines, and their arrays;
17. execute multiple patterns with specific print parameters in a single run;
18. allows re-inking pens during print runs; and
19. monitor status and remaining time of the print process.

In one embodiment, a main window can be built into the software which can provide imaging, further menu bars, icons to activate functions, data entry sections, and information read-out sections.

In one embodiment, for example, software can be prepared and used which provides for two categories of operation: (i) motion control, and (ii) array configuration. For example, the motion control software can be used to access frequently used routines, including for example pre-tuned stage displacement and specified locations. In addition, array configuration software can be used to specify individual dots and lines and arrays of dots and lines.

The software main window can provide, for example, a menu bar with options including project, configure, pattern, window, and help options. The main window can show current positions and target positions for the pen and the x, y, z, and Tx, and Ty tilt positions. The main window can also show, for example, approach calculations and inkwell information.

Under a project option, for example, information can be entered and accessed which is project information related to, for example, date and time, sample, ink(s), writing tool, writing conditions, pattern configurations, and pattern location.

Under a configure option, for example, one can set safe motion parameters such as for example minimum and maximum travel distances for each axis.

Under a pattern option, for example, one can open a window to specify dot and line features and their array configuration. Parameters include, for example, the number of arrays and number of elements within an array, spacing between the arrays and the elements in X and Y directions, position of the first array and first element taking into account that positive values in the spacing tab can result in printing features bottom up left to right and vice versa.

Other pattern parameters can be controlled by software.

For example, arrays can be generated with information entry for number of arrays, spacing, and origin. Here, a “repeat” parameter can control the number of times the array or element is to be repeated after the first complete run. For example, for a pattern containing five arrays of 100 dots repeat “2” in the array field can mean that after all five arrays are completed they will be repeated two more times.

For drawing dots, one can enter information, for example, for number of dots, spacing, and origin. A “dwell time” parameter can mean, for a dot generation, how long the writing pen remains in contact with sample surface to deposit ink or molecules.

For drawing lines in the X and Y directions, one can enter information for number of lines, spacing, and origin. One also can set a “line length” which can be the same for both axes. One can also set speed of writing.

A “speed” parameter, controlled by software, can be the rate of pen movement over the substrate surface to build a line.

A motion control panel can include the following exemplary features for a manual operation of the stages: a plurality, for example nine, fixed motion increments (in for example microns, e.g., one micron or five microns or 100 microns, and a low speed (LS) setting, motion controls (check box, motion arrows, start button, feedback position) per each stage. Motion increment buttons can be used to apply selected travel to all stages. The active motion increment can be highlighted. By pressing, for example, a key such as “<” or “>” arrows the related stage can execute the displacement. For each axis and for each motion increment, there can be optimized PID settings determined during the tuning process. Technically, by pressing the increment buttons, the related PID settings can be loaded to the controller. PID settings can be stored in an ACS file that can have, for example, a plurality of buffers such as ten buffers. Each buffer can contain information about PID setting for a particular motion. Desired PIDs can be loaded by running the related buffer. Each motion can have a letter indicating the axis, a square box to check or uncheck the axis, motion arrows to choose motion direction and a tab presenting absolute coordinates of the stage (the feedback). In addition to incremental motions, one can generate continuous motion by holding the arrows. Also, for very precise positioning one can type particular coordinates into the position box on the right side and then press a Start button to execute the motion. A commercial motion control panel can be adapted for particular configurations.

In a Layout panel section, the current position of the stages can be saved at any time by pressing one of the buttons in the Layout panel and then pushing a “Capture” button. To execute a saved position, it can be enough to press the related button and then “Go To” button. There can be for example ten available buttons on a Layout panel. The first three, P1, P2, and P3 for example, can be used only to define the sample plane that is part of a procedure to calculate Approach set points. Other buttons can be used to save positions of one or more inkwells. Other buttons can be used for any position.

In an Approach button section, each sample such as a glass slide or a custom substrate, can have specific Z and T values. One can define the top plane of the sample in order to calculate approach points for any X/Y position. To do that a user can manually approach the substrate surface at three different locations which define a plane. Another way to do this is to start at the most negative X and Y values, then to keep Y constant, and move to the most positive X, and finally move to the most positive Y.

These three points typically occur at corners of a rectangular substrate. At each position (e.g., P1, P2, and P3), the X, Y, and Z are acquired by pressing a Capture button on the Layout panel. The coordinates of the three points are used to define a plane using the three points plane equation. Upon pressing the Calculate button, the equation of the plane will be solved for Z as a function of X and Y. Now, when the Approach button is pressed, the application will use the derived equation to calculate Z for any particular X and Y. By pressing the Approach button, the program algorithm can read X and Y coordinates, then put them into the equation to calculate the particular Z, and finally execute the desired Z motion. Hence, one embodiment provides that the controller comprises software to enable definition of the substrate plane.

### Applications

The instrument and apparatuses described herein can be used in a wide variety of applications.

In some applications, material is deposited onto the surface which has not yet been patterned. In other applications, material is deposited onto the surface, wherein the surface comprises a defect in need of repair. For example, additive repair can be carried out. The surface can be pretreated or indexed as needed for a particular application. Surfaces can be rendered hydrophilic or hydrophobic, and roughness can be controlled.

One application is in the fabrication of electronic circuits based on combinations of insulative, semiconductive, and conductive features. Electronic parameters can be measured. See for example 2004/0026681.

One application is in photomask repair. See for example 2004/0175631.

One application is in flat panel display repair. See for example 2005/0235869.

Fabricated surfaces can be further subjected to etching, wherein the materials deposited onto the surface act as etch resists. See for example 2006/0014001.

Nanoscale testing can be carried out as described in for example 7,199,305.

One particularly important application is in the field of bioarrays or microarrays or nanoarrays including protein arrays and DNA arrays. See for example Microarrays, Muller, Roder, 2006; Microarrays for an Integrative Genomics, Kohane, 2003. The arrays fabricated as described herein can be further analyzed by fluorescent and scanning probe methods including AFM methods. For example, diagnostics can be done with these arrays. Additional description for bioarrays can be found in for example U.S. Pat. No. 6,573,369.

Arrays can be based on dots or lines. One particularly important embodiment comprises arrays of oligonucleotides and cDNA. For example, oligonucleotides can have for example 5 mers to 60 mers. The oligonucleotides can be modified or adapted at the terminal position for chemisorption or covalent bonding to the substrate surface. Other compounds for inks in patterning on surfaces can be based on, for example, 2 mers to 150 mers.

Oligonucleotide hybridization assays can be carried out . Examples include HIV, W, BA, and EV hybridized arrays.

When arrays are made, AFM phase images of the arrays can be carried out showing shape and size consistency within the array. For example, the feature size can be 210±5 nm.

One aspect of this technology is delivery of ink to places where it can be used including for example microfluidics and inkwells and reservoirs. See for example 2005/0035983 and U.S. Pat. No. 7,034,854.

Arrays can be periodic or non-periodic.

The instrument can be used as a plotter and can be used to draw a wide variety of shapes including continuous lines and dots.

Force feedback can be used as desired.

Software can be integrated with the instrument to automate the operation and/or to improve the quality of the printing results.

Presynthesized molecules can be spotted.

Nanoassemblies can be built by integrating molecules into prefabricated MEMS.

Layer-by-layer growth can be achieved by sequential deposition of solutions.

Solid phase synthesis can be carried out. One example is in situ molecular synthesis via multiplexed ink delivery. Another example is making templates for further molecular assembly through chemical synthesis. Another example is ordered supramolecular assemblies based on coordination chemistry.

### Working Embodiment/Example

Non-limiting working example is described. As an example of a multi-axis assembly, a 5-axis assembly instrument was built based on the following non-limiting specifications for the multi-axis assembly comprising five stages of independent motion:
The XY travel is at least 40 mm in X direction and Y direction.
The Z travel is at least 20 mm.
The tip/tilt travel is at least ±10 degrees.
Position feedback is provided by precision linear encoders with 5 nm resolution.
Actual linear resolution for X, Y, and Z motions is at least ±15 nm and at least ±15 nm for repeatability.
The angular resolution is at least ±0.001 degree.
The lowest guaranteed travel speed is at least 100 nm/sec.
The highest travel speed is at most 1-10 mm/sec.

A vendor can be used to fabricate the multi-axis assembly within these specifications. One vendor, for example, is NanoMotion, Ltd. (Yokneam, Israel; a Johnson Electric Co.). Alternatively, one can refer to other vendors in nanopositioning technology or to the technical literature on how to assemble a multi-axis assembly.

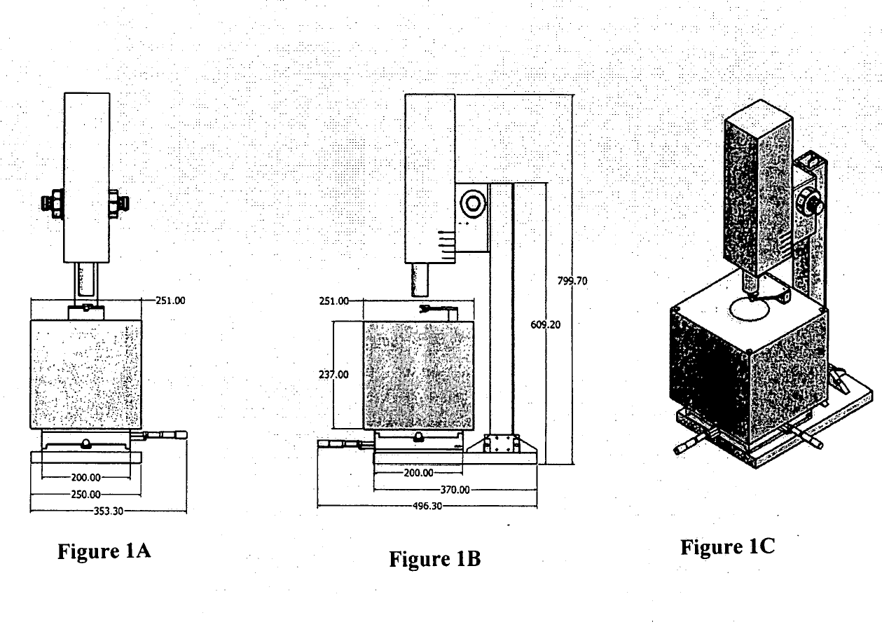

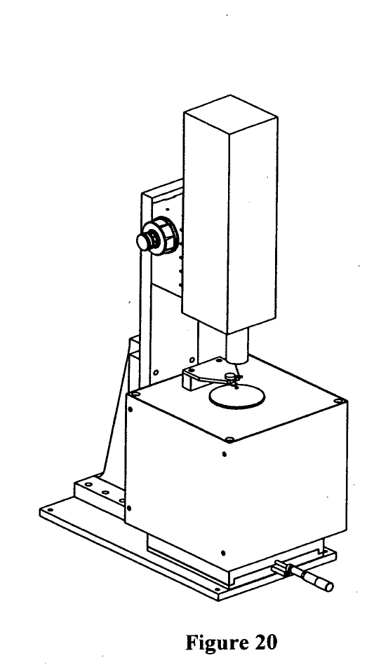

FIGS. 1(a)-(c) illustrate the larger instrument including the microscope and enclosure for the multi-axis assembly. See also FIG. 20.

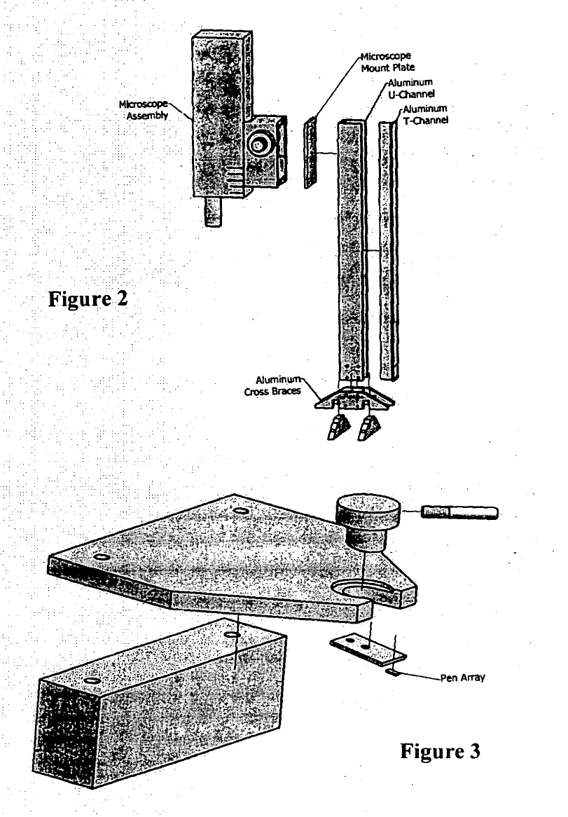

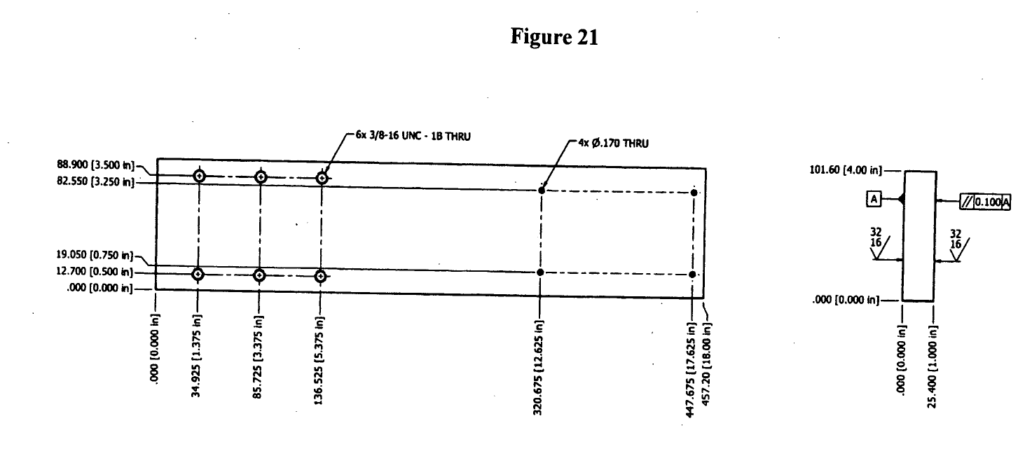

FIG. 2 illustrates an embodiment for the microscope showing the microscope, microscope mount plate, and U-channel braces, as well as cross braces. This design provides strength and saves weight. It allows cables to be run down the center of the channels and exit out the side of the U-channel (not shown). FIG. 21 illustrates one example of a microscope mount plate.

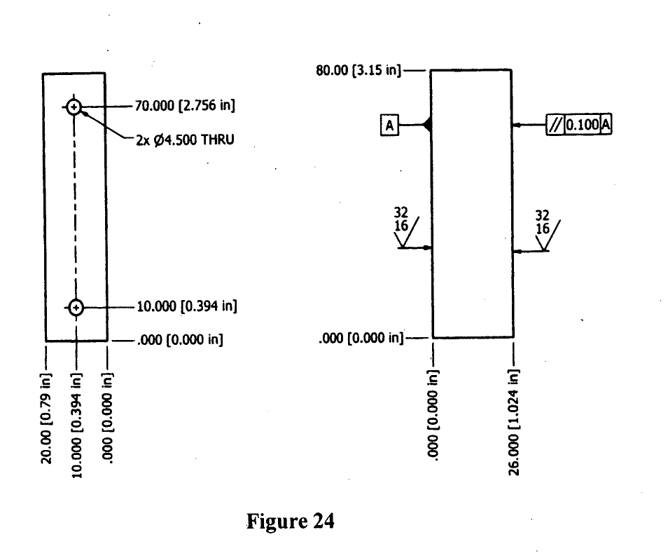

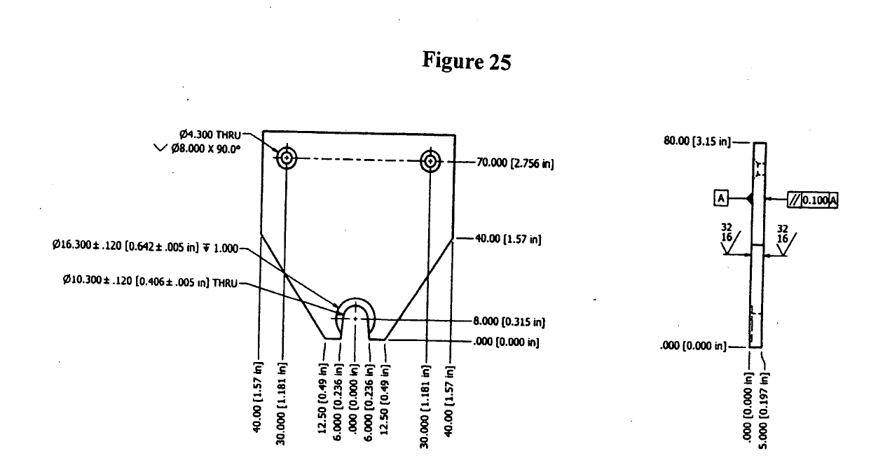

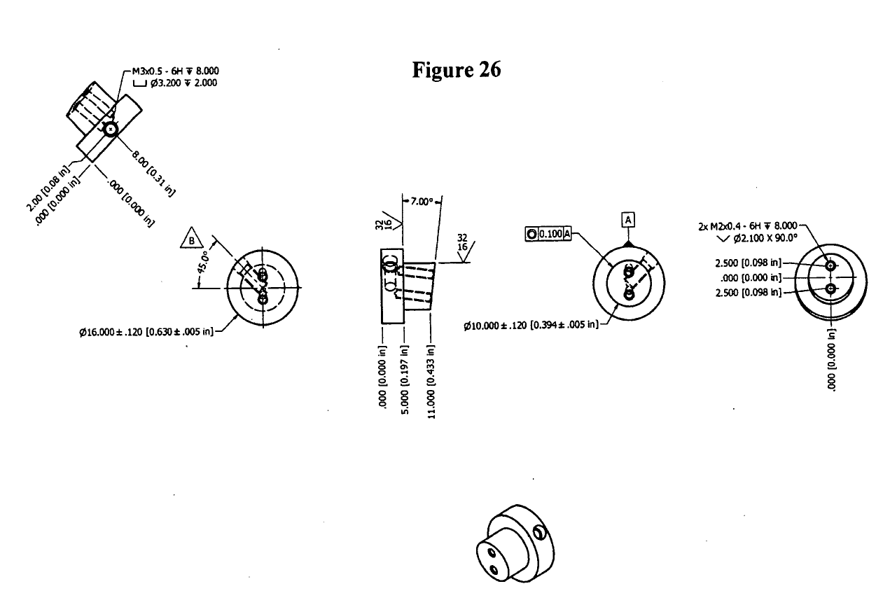

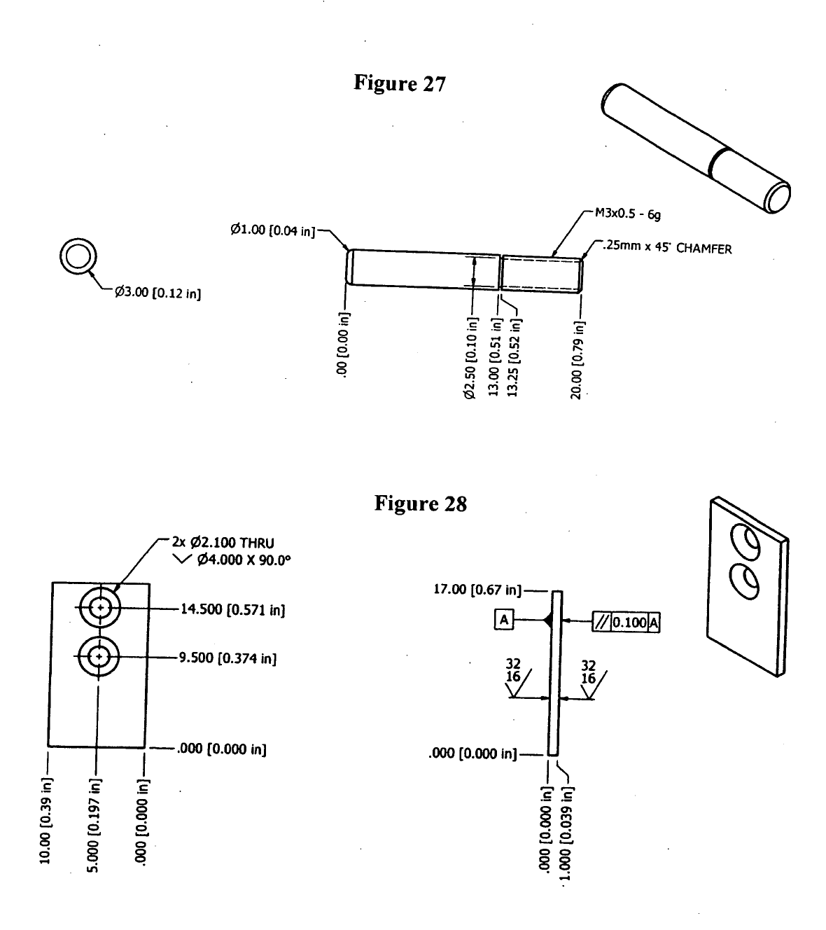

FIG. 3 shows an embodiment for an assembly for mounting the pen array. The pen array can be glued to this assembly. The assembly can comprise a block for a pen base as illustrated in for example FIG. 24. The assembly can further comprise a plate for the pen base as illustrated in for example FIG. 25. The assembly can further comprise a disk for a pen holder as illustrated in for example FIG. 26. The assembly can further comprise a lever as illustrated in for example FIG. 27. The assembly can further comprise a plate for the pen holder as shown in for example FIG. 28.

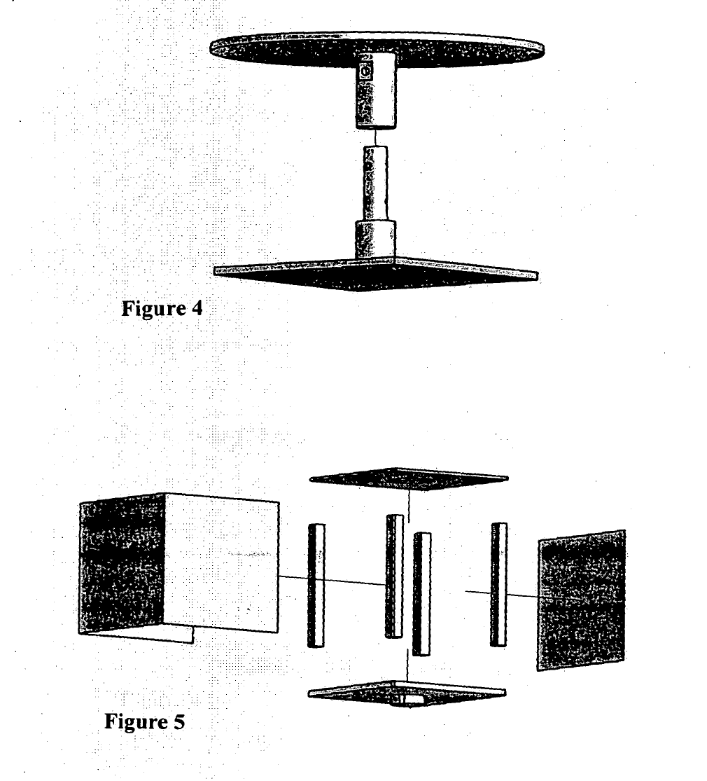

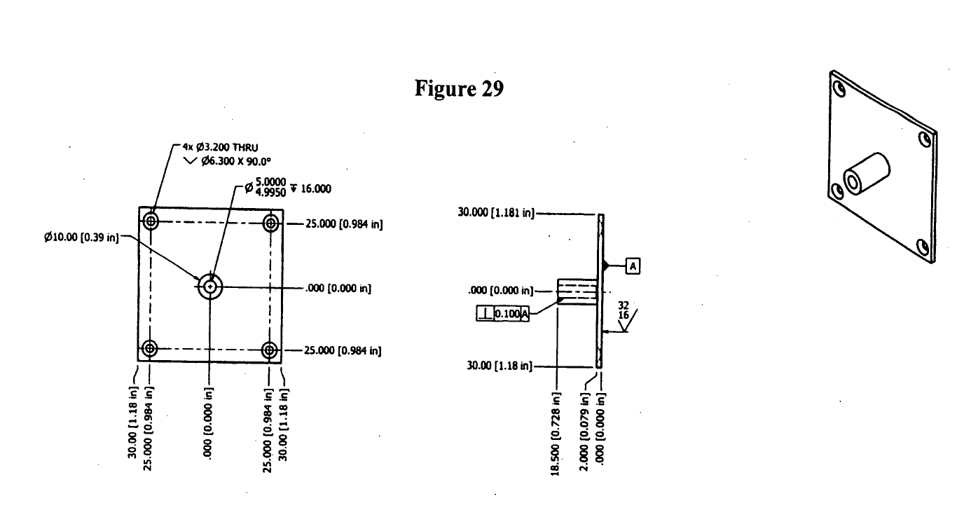

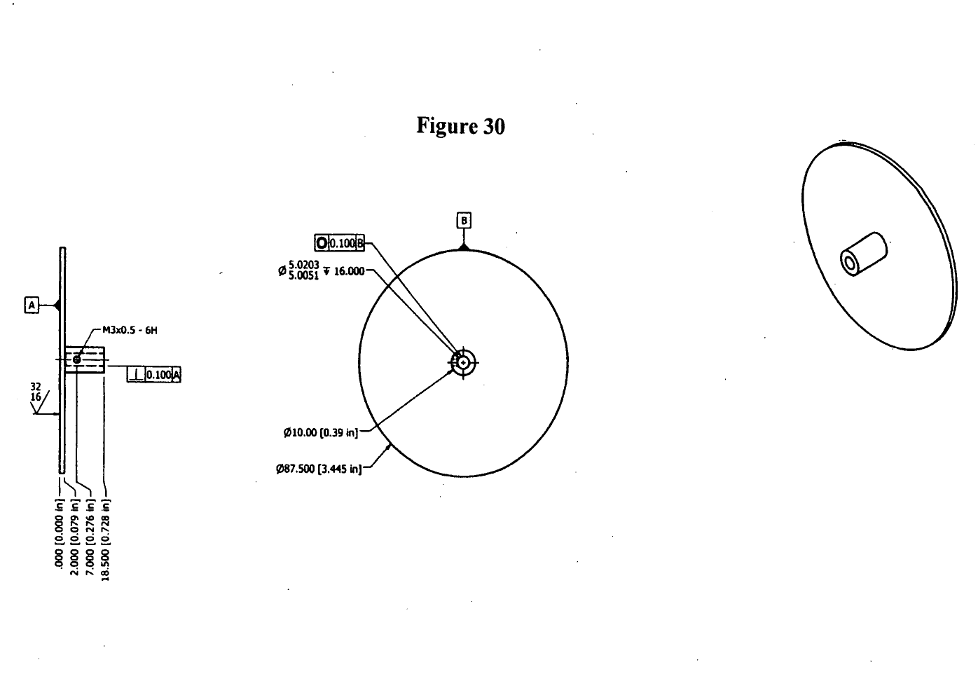

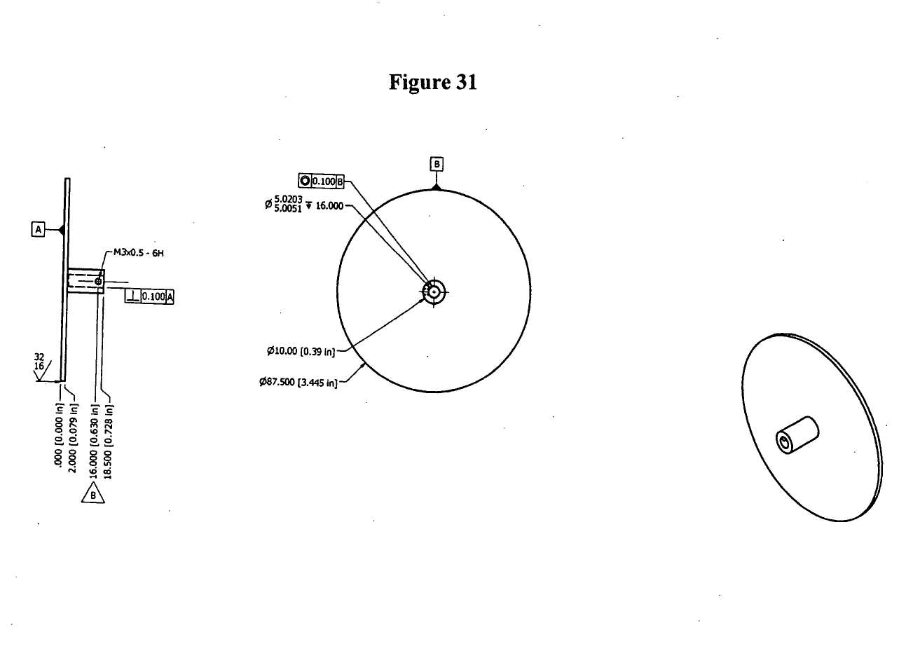

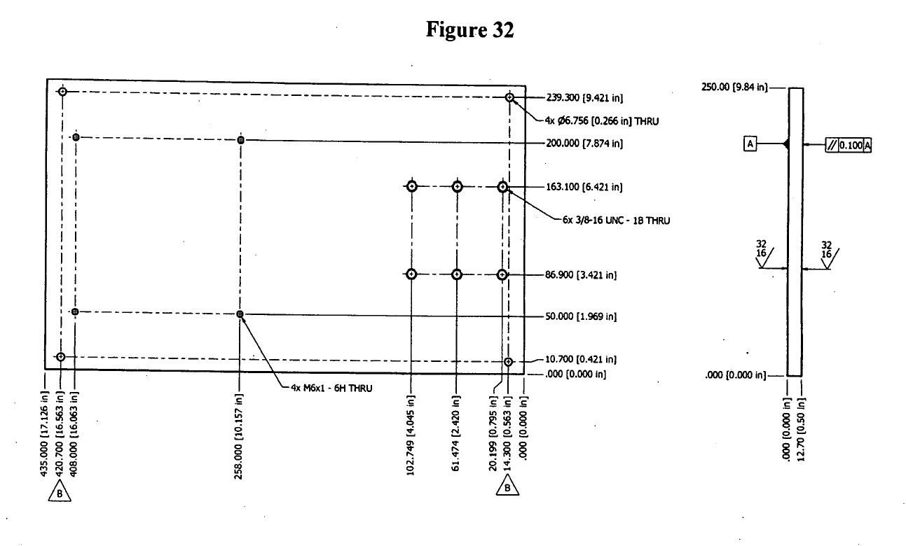

FIG. 4 shows a table assembly for mounting on top of the multi-axis assembly. The top part of the assembly can be either left floating to allow for rotational adjustment, or a bolt can be put in place for a solid connection. A substrate can be put on this table assembly. The bottom part can be fabricated as shown in for example FIG. 29. The top part can be fabricated as shown in for example FIGS. 30 and 31.

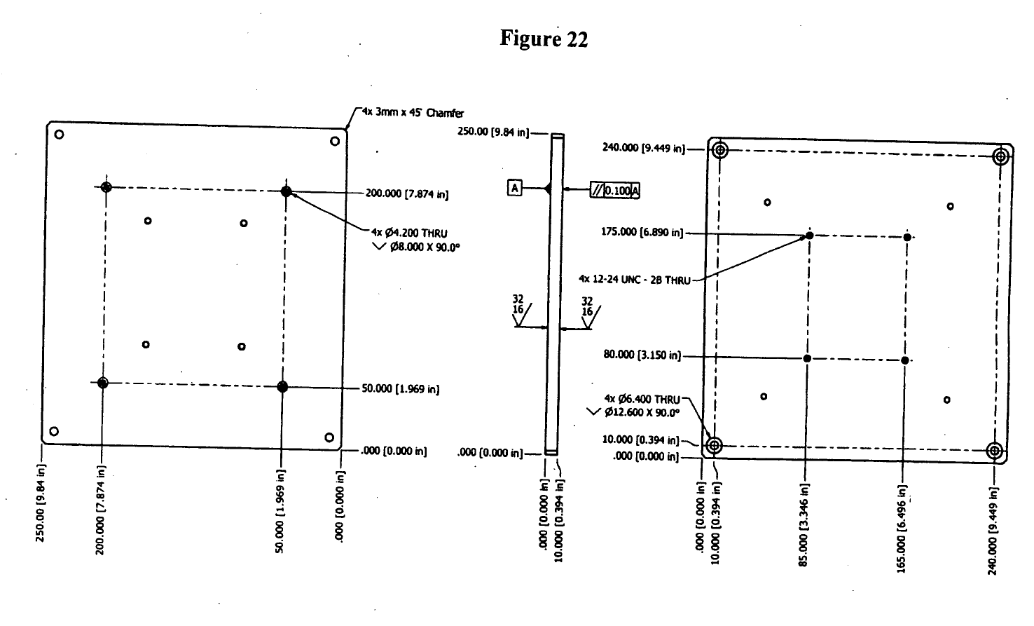

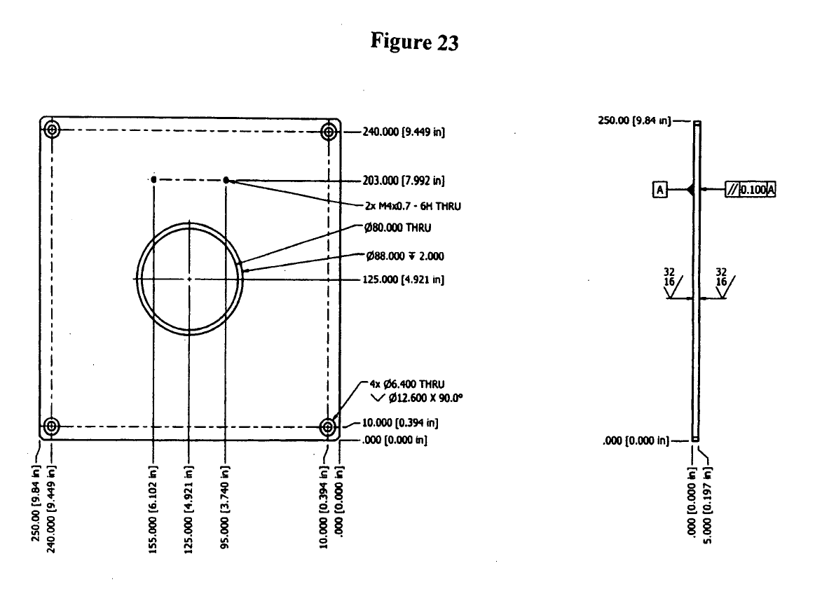

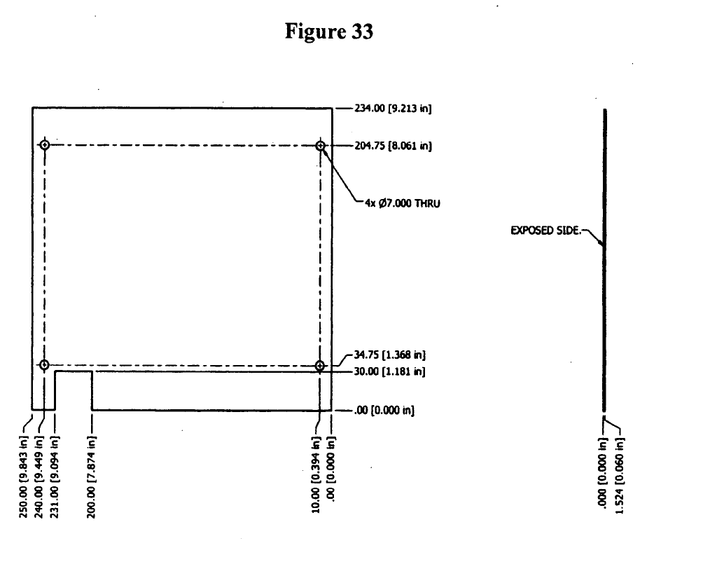

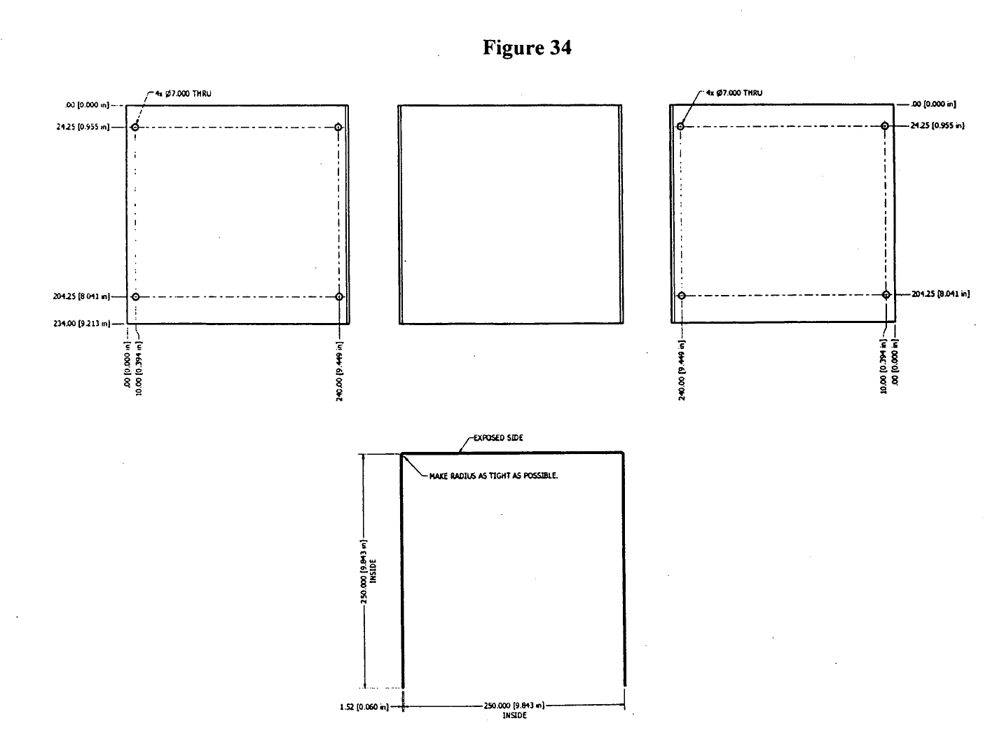

FIG. 5 shows an enclosure assembly for the multi-axis assembly. The enclosure comprises four square rods, a top plate, a bottom plate, two sheet metal sides. The bottom plate can comprise an extrusion so that the enclosure can sit on an XY table. This option allows the enclosure to be rotated if required. Or the enclosure can be secured to the XY table for a solid mount. FIG. 22 further illustrates an example of a bottom plate. FIG. 23 further illustrates an example of a top plate. FIG. 33 illustrates an example of a rear enclosure. FIG. 34 illustrates an example of a front enclosure.

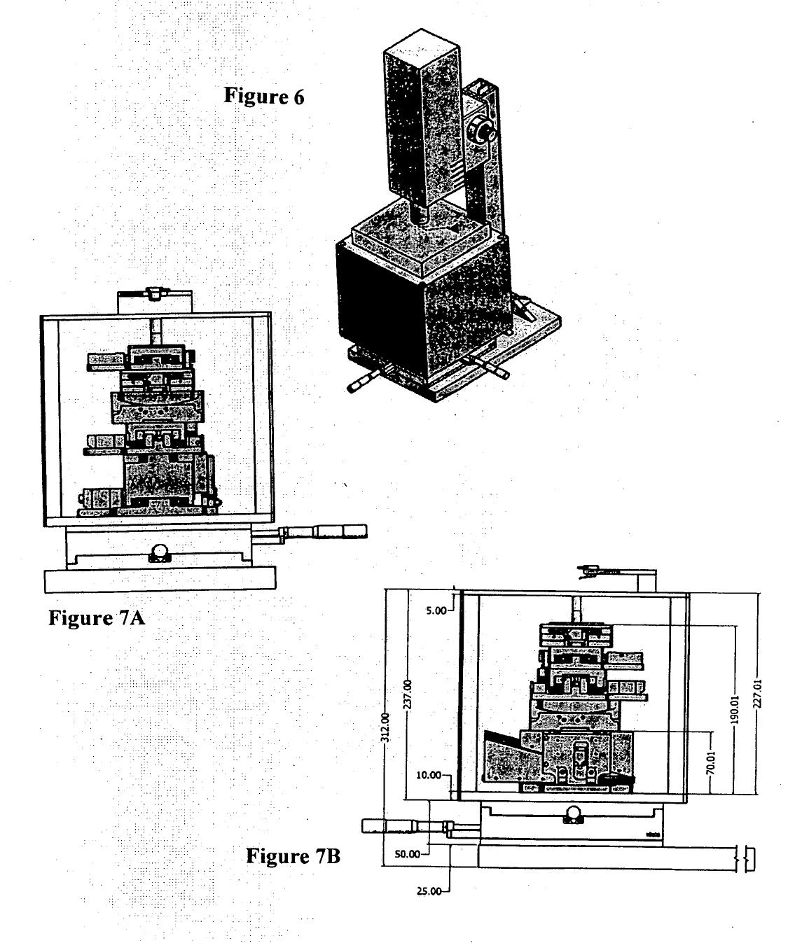

FIG. 6 shows an environmental chamber which can allow control of for example temperature, humidity, and flow of gasses other than the surrounding room's atmosphere.

### Motion Study

FIGS. 7-13 illustrate the multi-axis motion step-by-step.

In FIG. 7, the multi-axis assembly is shown at its lowest position. The pens are not in contact with the substrate which would sit on top of the table assembly.

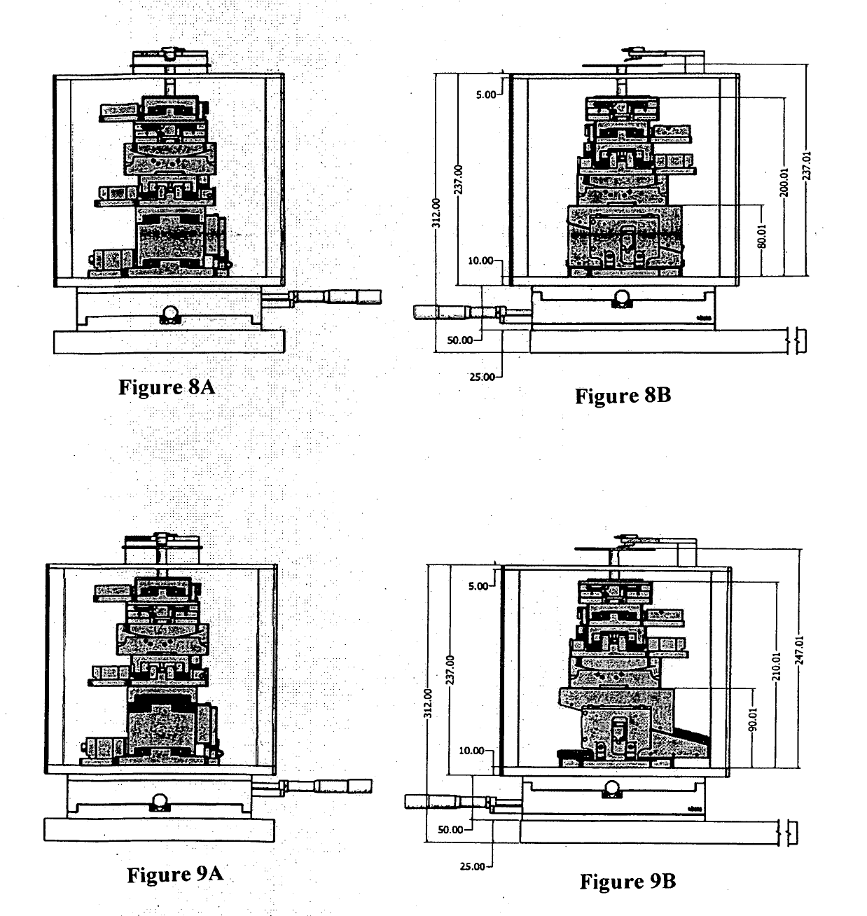

In FIG. 8, the Z-axis stage elevates the table assembly and substrate, although it is not yet in contract with the pen.

In FIG. 9, the Z-axis stage has not elevated the table assembly and substrate sufficiently that the pen is now in contact with the substrate.

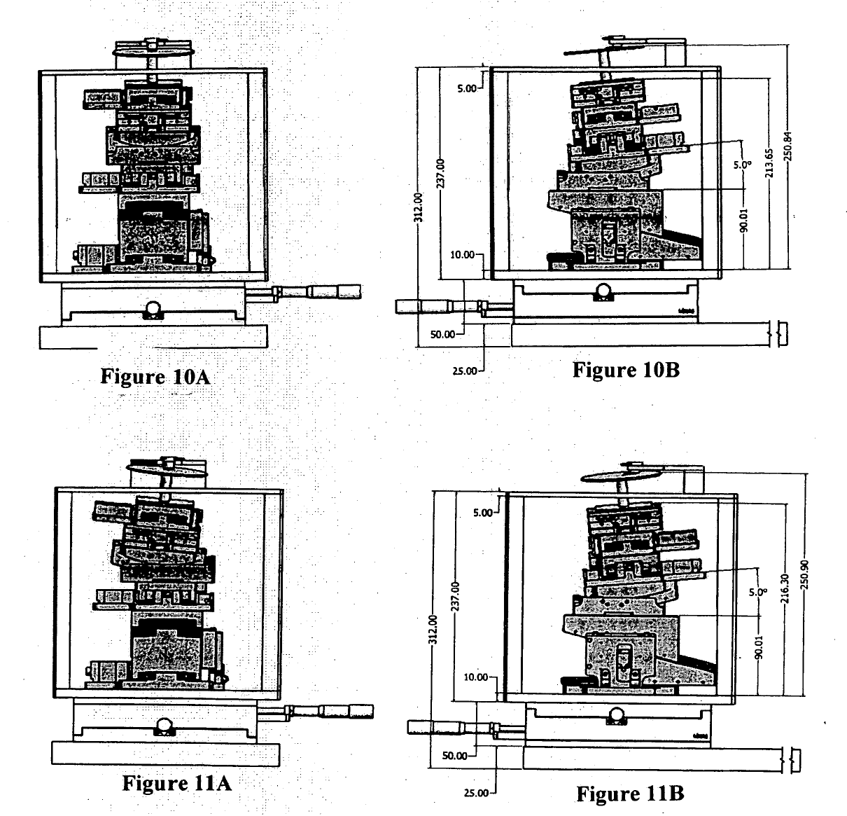

In FIG. 10, the table assembly and substrate are tilted at five degrees by a second stage.

In FIG. 11, the table assembly and substrate are tilted again at five degrees by a second stage, wherein the tilt is orthogonal to the tilt of the FIG. 10 tilt.

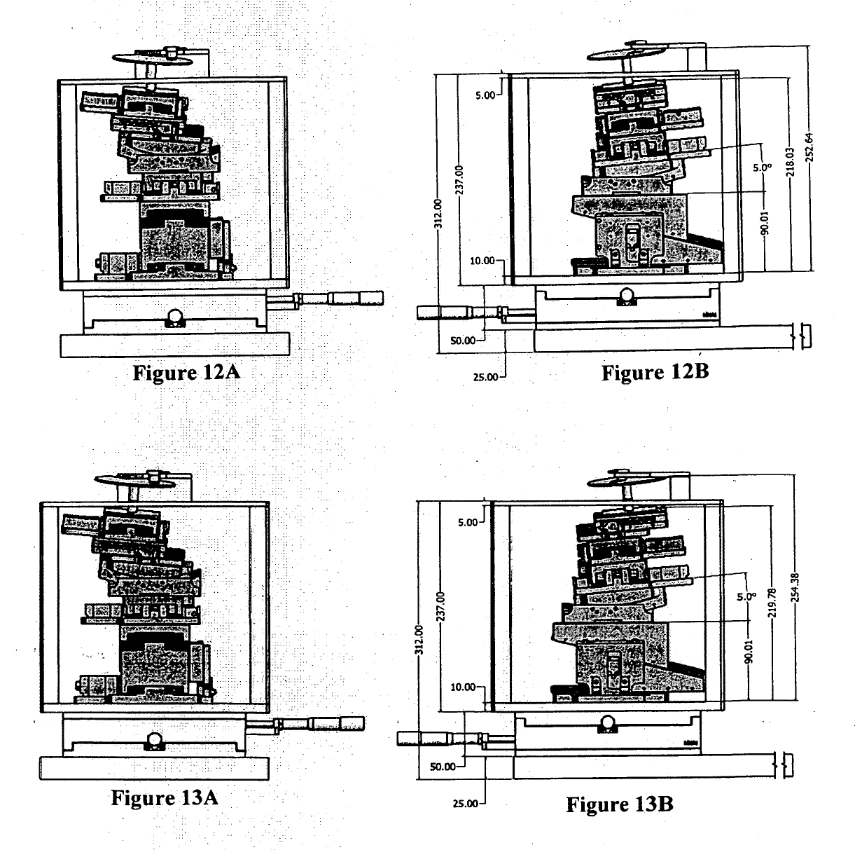

In FIG. 12, the table assembly and substrate are moved by a fourth stage 20 mm.

In FIG. 13, the table assembly and substrate are moved by a fifth stage another 20 mm, wherein the move is orthogonal to the movement of FIG. 12.

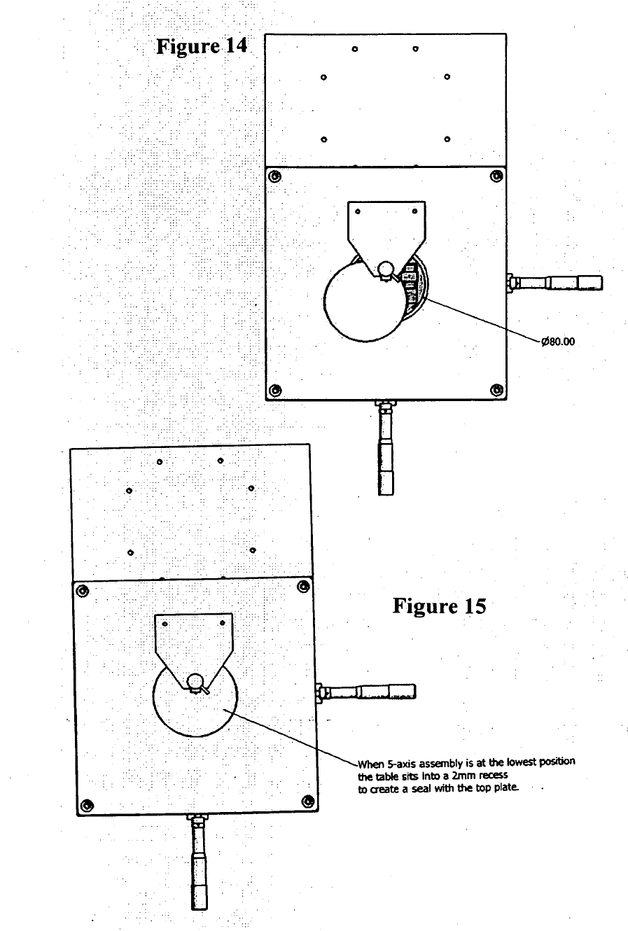

FIG. 14 shows the top view of the top plate at most extreme position.

FIG. 15 illustrates a top view of the top plate at lowest position. Here, for example, the table can sit into a 2 mm recess to create a seal with the top plate. The table can function therefore as a cover which can help prevent foreign objects from falling into the housing.

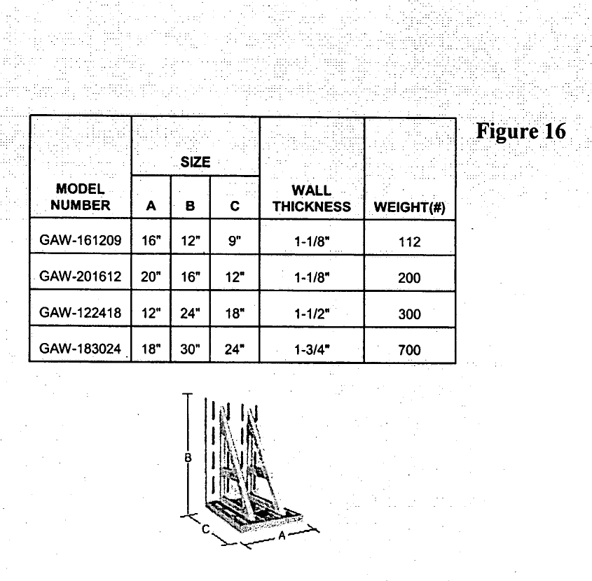

FIG. 16 illustrates microscope mount designs.

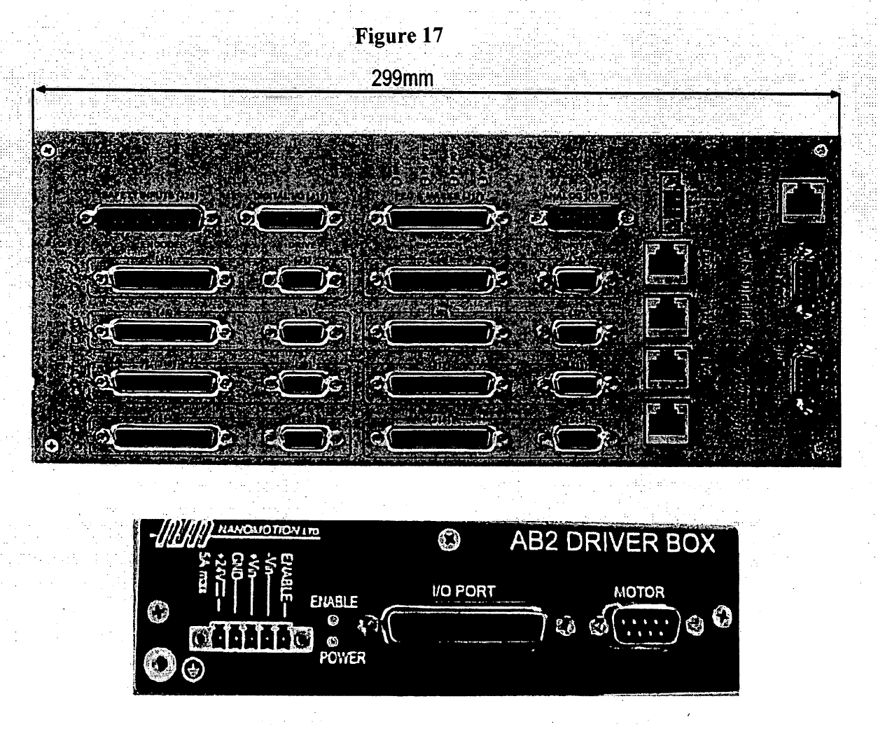

FIG. 17 illustrates an ACS controller and an AB2 Driver Box Front panel.

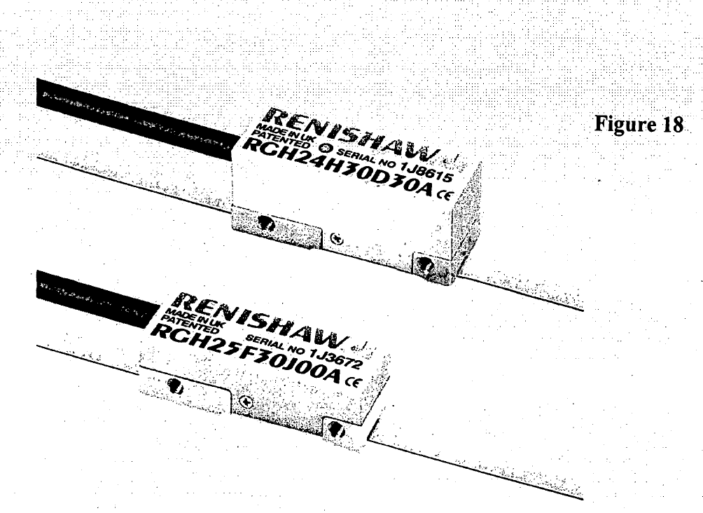

FIG. 18 illustrates a Renishaw 0.1 micron resolution RGH encoder.

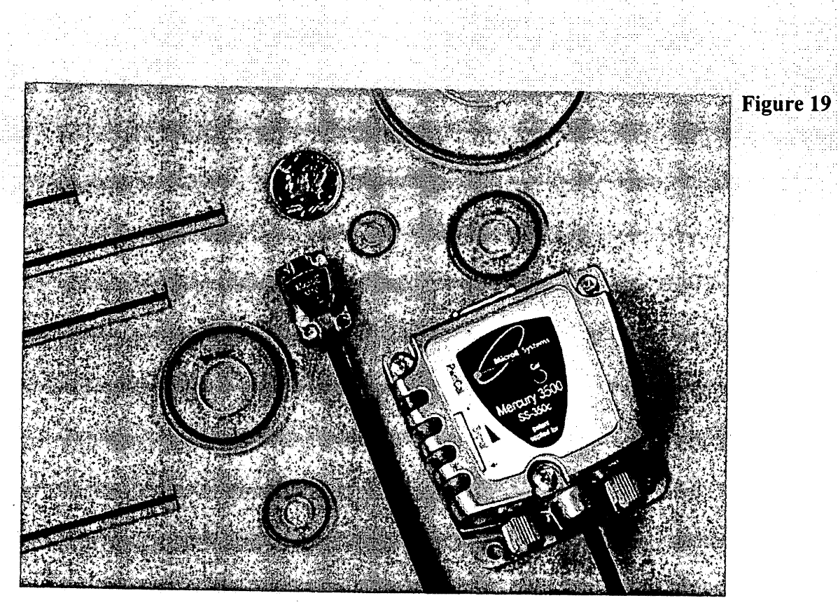

FIG. 19 illustrates a Mercury TM3500 Smart Encoder Systems.

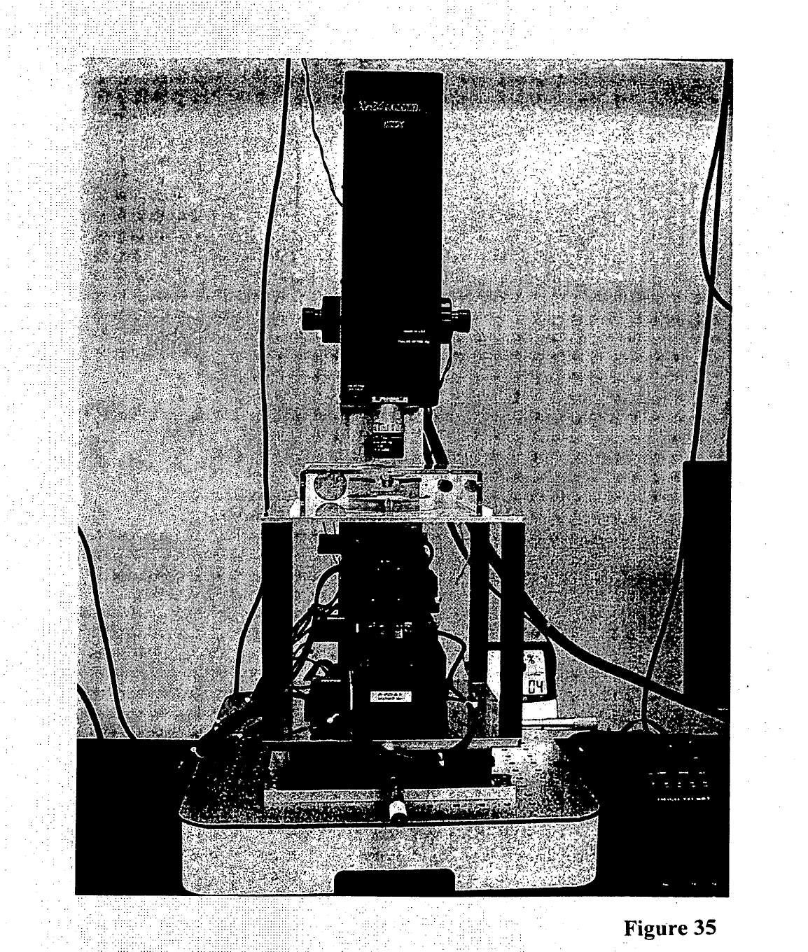

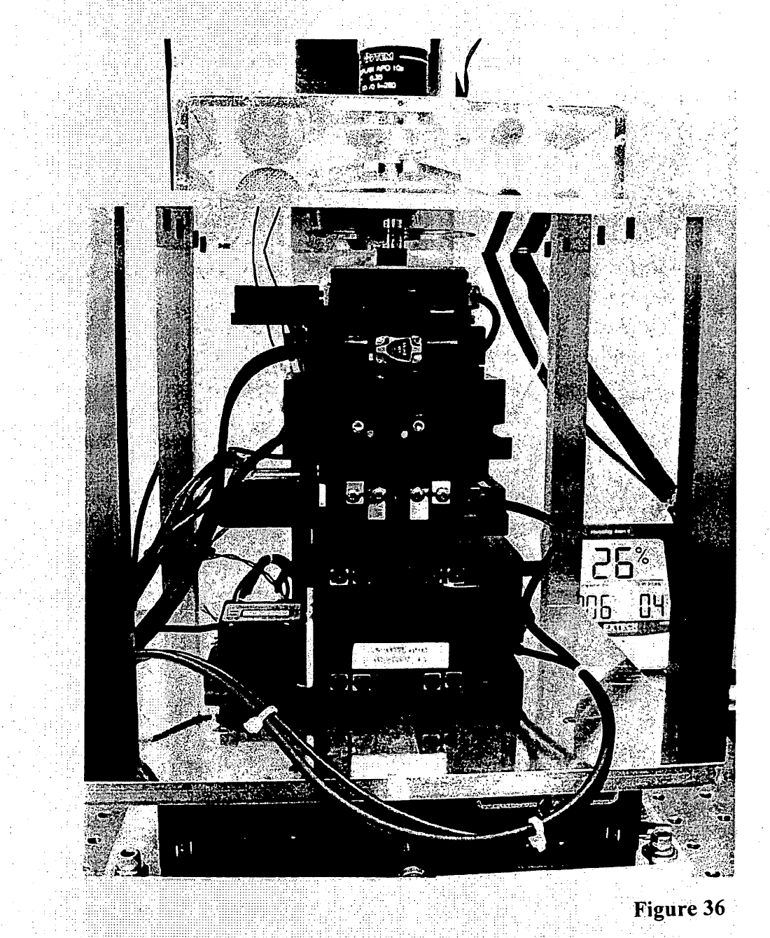

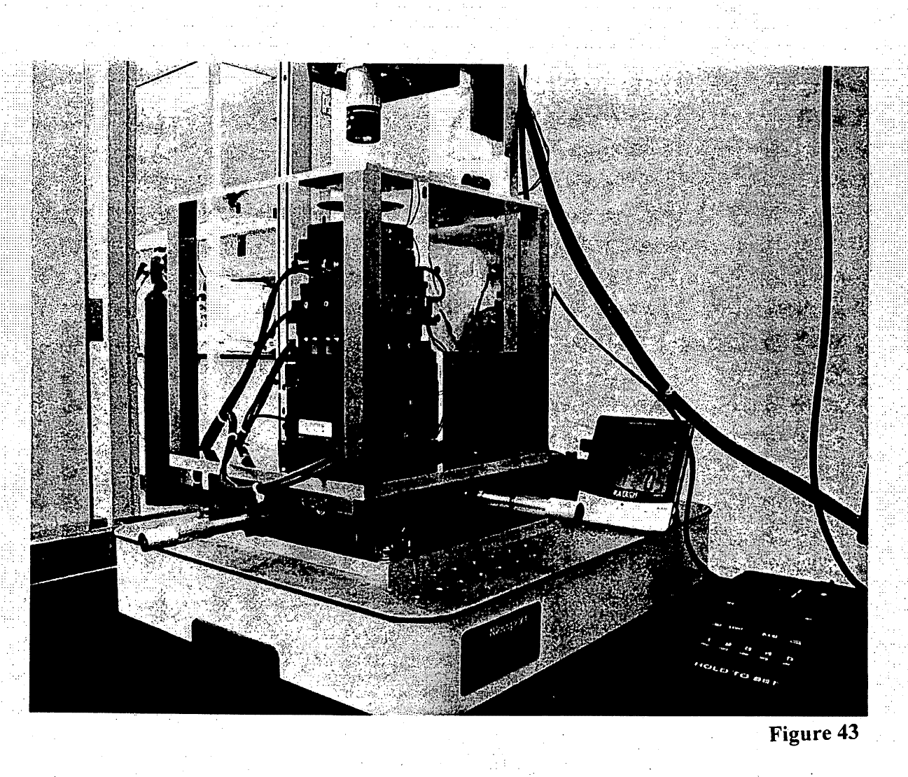

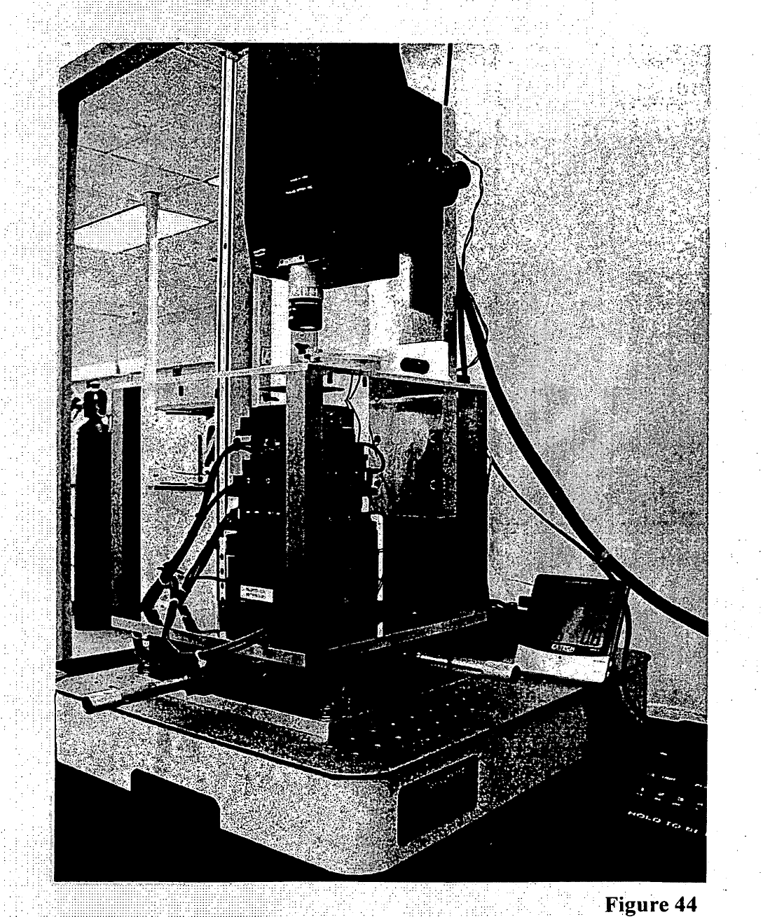

FIGS. 35-46 provide additional perspective photographs of a working model.

In FIGS. 35-36 and 43-44, the side panels of the enclosure for the multi-axis assembly are removed to allow viewing of the multi-axis assembly in a working model.

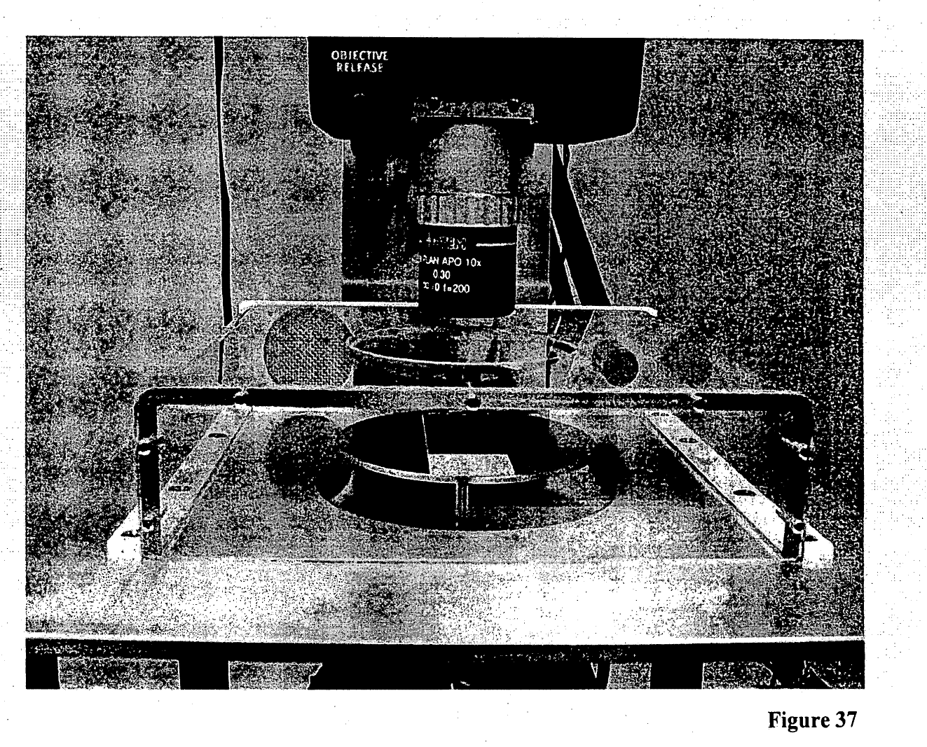

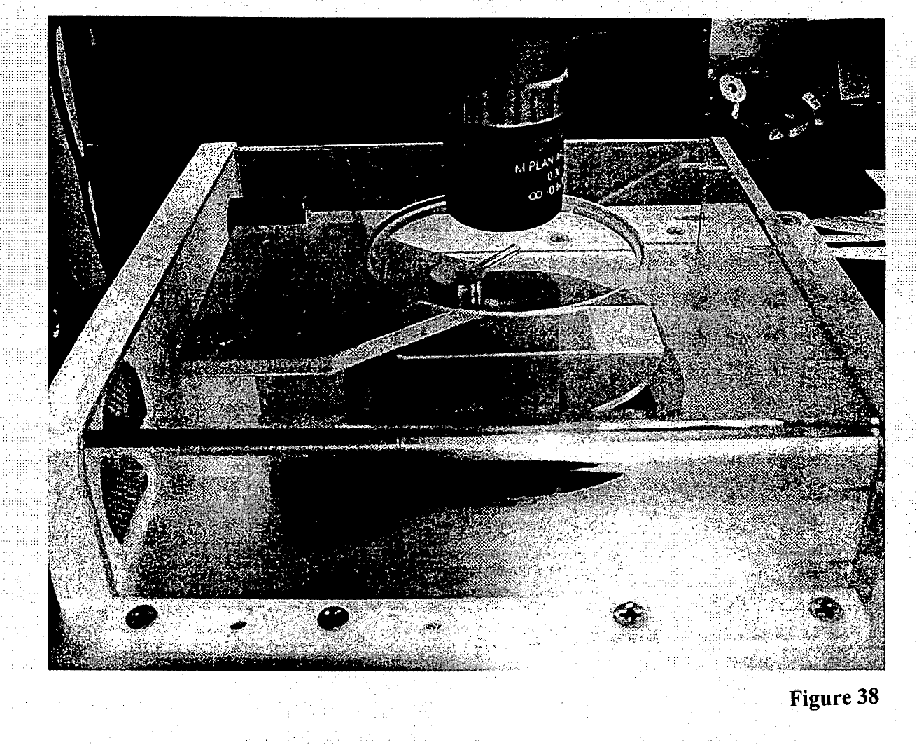

FIGS. 37-38 shows the environmental chamber including a hole or view port for viewing by the microscope in a working model.

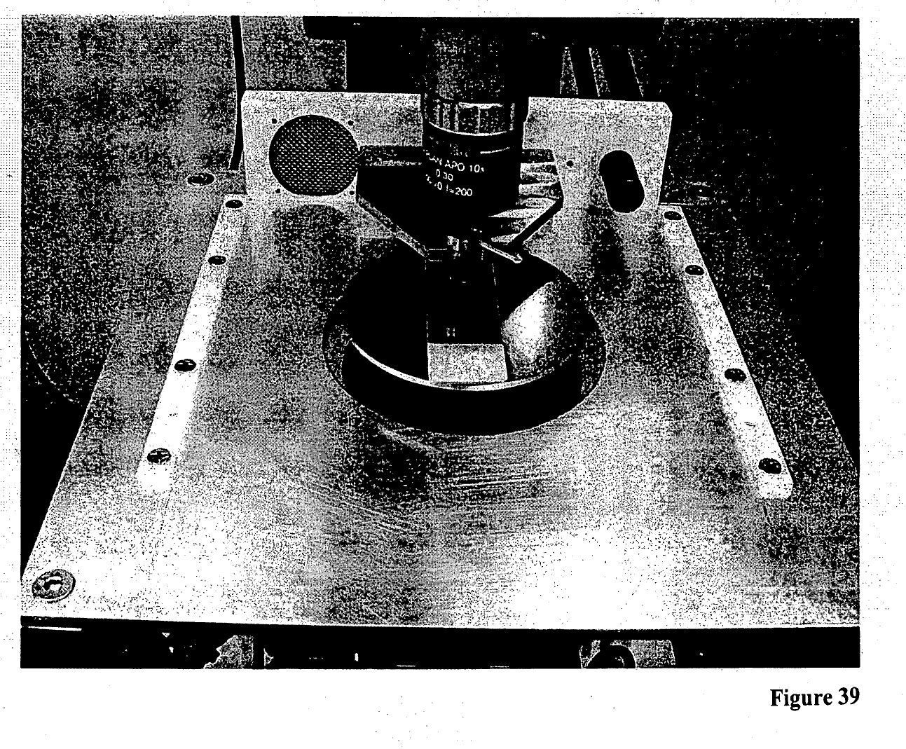

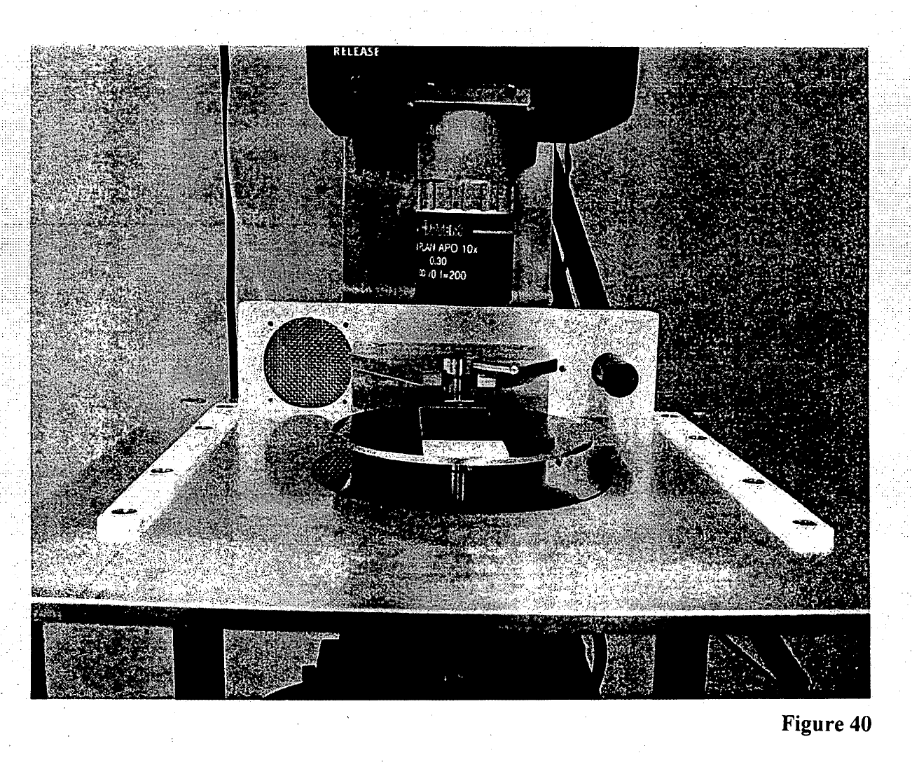

In FIGS. 39-40, the environmental chamber is removed to better show the pen assembly and the table assembly and substrate on the table assembly in a working model.

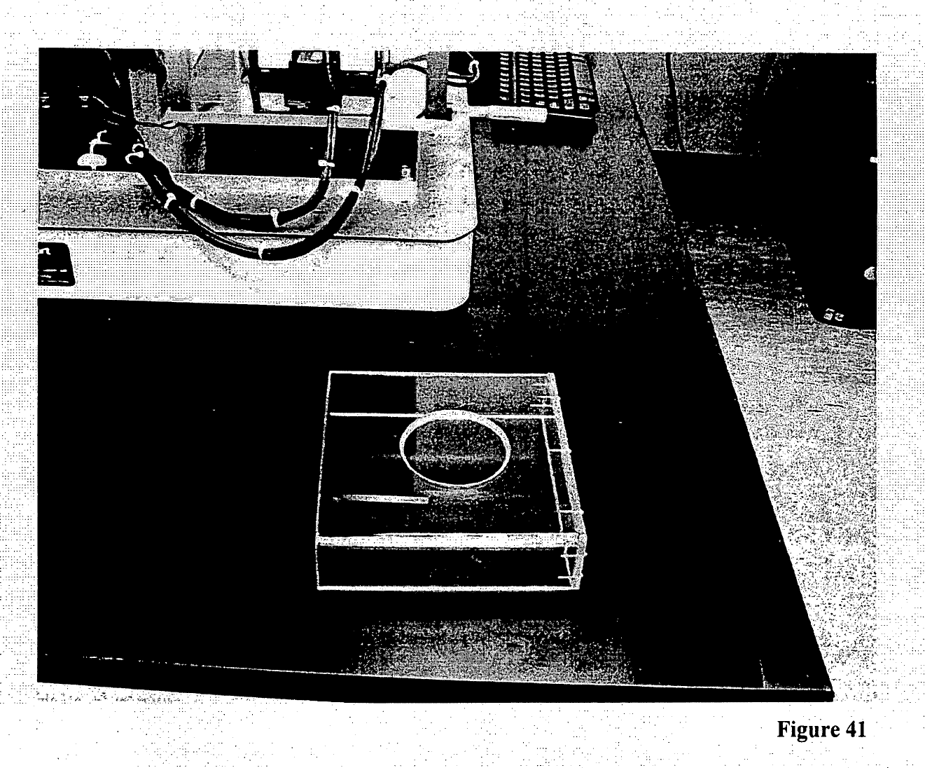

FIG. 41 shows the environmental chamber removed from the instrument in a working model.

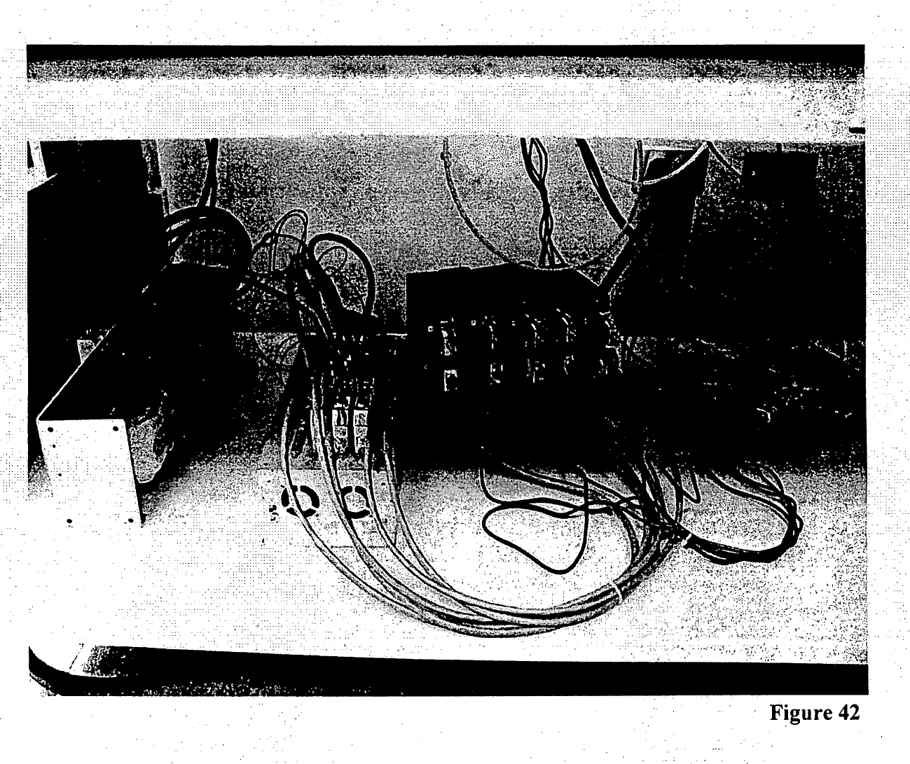

FIG. 42 shows wiring in a working model.

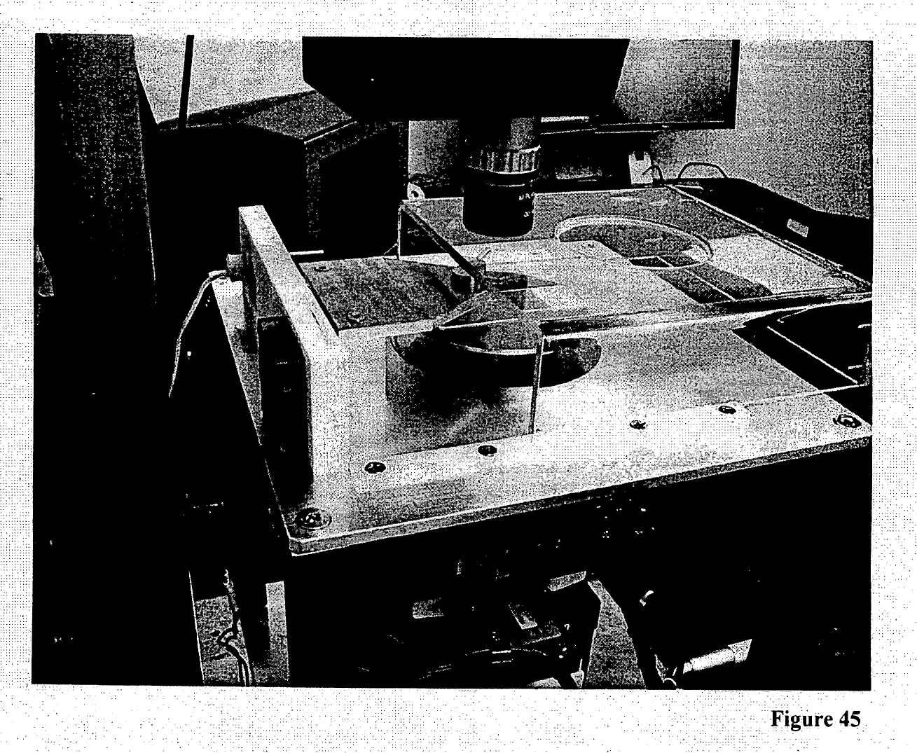

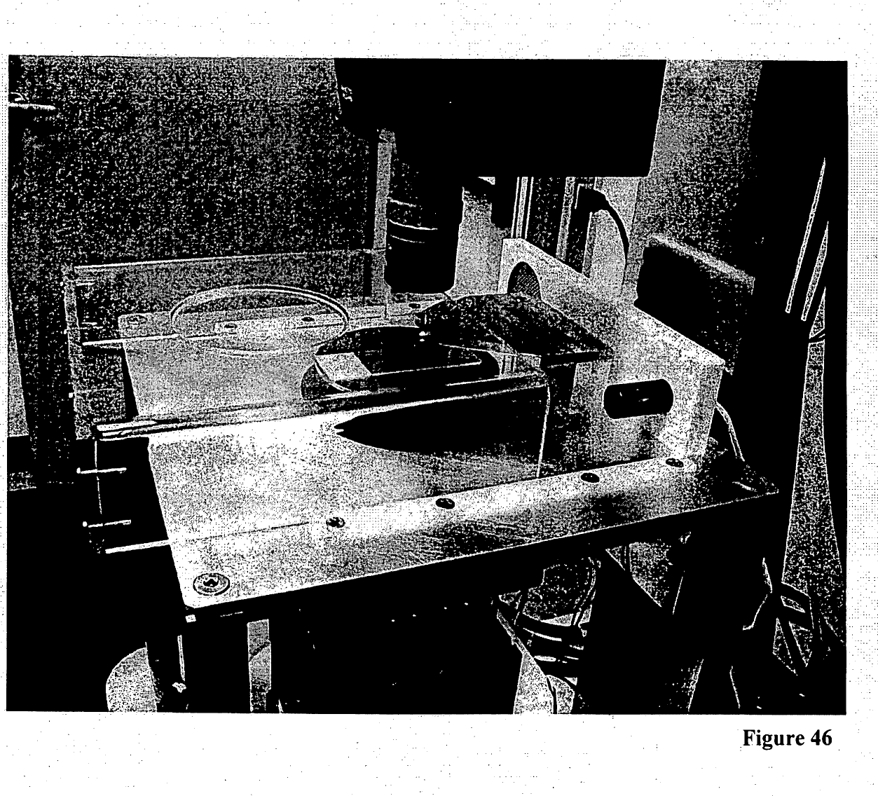

FIGS. 45 and 46 show insertion of the environmental chamber in a working model.

While the working model illustrates one or more embodiments, other embodiments different than the working model can be within the scope of the claimed inventions.

What is claimed is:

1. An apparatus comprising:
at least one multi-axis assembly comprising at least five nanopositioning stages,
at least one pen assembly,
wherein the pen assembly and the multi-axis assembly are adapted for delivery of material from the pen assembly to a substrate which is positioned by the multi-axis assembly,
at least one viewing assembly,
at least one controller.

2. The apparatus according to claim 1, wherein the multi-axis assembly comprises five independent stages including at least one X-stage, at least one Y-stage, at least one Z-stage, a first tilt stage, and a second tilt stage which provides tilt orthogonal to the tilt of the first tilt stage.

3. The apparatus according to claim 1, wherein the nanopositioning stages comprise piezoelectric nanopositioning stages.

4. The apparatus according to claim 1, wherein the multi-axis assembly comprises five independent stages including at least one X-stage, at least one Y-stage, at least one Z-stage, a first tilt stage, and a second tilt stage which provides tilt orthogonal to the tilt of the first tilt stage, wherein the stages are actuated by piezoelectric mechanisms.

5. The apparatus according to claim 1, wherein the multi-axis assembly comprises a sixth nanopositioning stage.

6. The apparatus according to claim 1, wherein the multi-axis assembly can move sufficiently so that delivery of material from the pen assembly to the substrate can occur over a substrate surface area of at least 20 mm×20 mm.

7. The apparatus according to claim 1, wherein the multi-axis assembly can move sufficiently so that delivery of material from the pen assembly to the substrate can occur over a substrate surface area of at least 40 mm×40 mm.

8. The apparatus according to claim 1, wherein the multi-axis assembly permits delivery of material from the pen assembly to the substrate at a maximum travel speed of 20 cm/sec or less.

9. The apparatus according to claim 1, wherein the multi-axis assembly permits delivery of material from the pen assembly to the substrate at a travel speed of at least 100 nm/sec.

10. The apparatus according to claim 1, wherein the multi-axis assembly is disposed on an XY translation stage.

11. The apparatus according to claim 1, wherein the apparatus further comprises an enclosure for the multi-axis assembly.

12. The apparatus according to claim 1, wherein the multi-axis assembly comprises an opening facing the pen assembly which is adapted for mounting a table assembly adapted so other components can be mounted.

13. The apparatus according to claim 1, wherein the apparatus further comprises a table assembly disposed on the multi-axis assembly for receiving the substrate.

14. The apparatus according to claim 1, wherein the apparatus further comprises an environmental chamber to surround the pen assembly and substrate.

15. The apparatus according to claim 1, wherein the apparatus further comprises an environmental chamber to surround the pen assembly and substrate, wherein the environmental chamber comprises an opening to facilitate viewing via the viewing assembly.

16. The apparatus according to claim 1, wherein the apparatus further comprises an environmental chamber to surround the pen assembly and substrate, and the environmental chamber is adapted to control temperature, humidity, and gas composition.

17. The apparatus according to claim 1, wherein the pen assembly comprises a one dimensional array of pens.

18. The apparatus according to claim 1, wherein the pen assembly comprises a two dimensional array of pens.

19. The apparatus according to claim 1, wherein the pen assembly comprises a two dimensional array of pens comprising at least 55,000 pens.

20. The apparatus according to claim 1, wherein the viewing assembly comprises a microscope.

21. The apparatus according to claim 1, wherein the viewing assembly comprises a microscope and is adapted to permit fluorescent detection.

22. The apparatus according to claim 1, wherein the viewing assembly comprises a microscope adapted for viewing structures to a resolution of at least 400 nm.

23. The apparatus according to claim 1, wherein the material comprises biological material.

24. The apparatus according to claim 1, wherein the controller controls at least the movement of the multi-axis assembly.

25. The apparatus according to claim 1, wherein the controller comprises software to enable delivery of material in the form of dots or lines on the substrate.

26. The apparatus according to claim 1, wherein the controller comprises software to control the atmosphere of gas in the environmental chamber.

27. The apparatus according to claim 1, wherein the nanopositioning stages comprise electrostatic nanopositioning stages.

28. The apparatus according to claim 1, wherein the nanopositioning stages comprise electromagnetic nanopositioning stages.

29. The apparatus according to claim 1, wherein the delivery is direct write nanolithography.

30. The apparatus according to claim 1, wherein the multi-axis assembly permits tilting of a substrate of at least 10 degrees.

31. An apparatus comprising:
at least one multi-axis assembly comprising at least one piezoelectric nanopositioning X stage, at least one piezoelectric nanopositioning Y stage, at least one piezoelectric nanopositioning Z stage, a first piezoelectric goniometer to provide tilt, and a second piezoelectric goniometer to provide tilt orthogonal to that of the first goniometer,
at least one pen assembly comprising an array of pens, wherein the pens comprise an array of cantilevers, and the cantilevers have tips disposed thereon,
wherein the pen assembly and the multi-axis assembly are adapted for delivery of material from the tips of the pen assembly to a substrate which is positioned by the multi-axis assembly,
wherein the multi-axis assembly is adapted to be coupled with an environmental chamber to surround the pen assembly and substrate and is also adapted to function with a removable table assembly on which the substrate is disposed,
at least one viewing assembly,
at least one controller.

32. The apparatus according to claim 31, wherein the pen assembly is adapted to move pens in a Z direction.

33. The apparatus according to claim 31, wherein the apparatus further comprises microfluidic devices for holding material to be delivered.

34. The apparatus according to claim 31, wherein the multi-axis assembly provides at least 20 mm of X motion, at least 20 mm of Y motion, and at least 10 mm of Z motion.

35. The apparatus according to claim 31, wherein the multi-axis assembly provides at least 40 mm of X motion, at least 40 mm of Y motion, and at least 20 mm of Z motion.

36. The apparatus according to claim 31, wherein the multi-axis assembly provides at least 5 degrees of tilt from the first goniometer, and at least 5 degrees of tilt from the second goniometer.

37. The apparatus according to claim 31, wherein the multi-axis assembly provides at least 10 degrees of tilt from the first goniometer, and at least 10 degrees of tilt from the second goniometer.

38. The apparatus according to claim 31, wherein the multi-axis assembly provides a travel speed of at least 100 nm/sec.

39. The apparatus according to claim 31, wherein the multi-axis assembly provides a travel speed of no more than 10 mm/sec.

40. The apparatus according to claim 31, wherein the multi-axis assembly provides angular resolution for tilt to at least 0.001 degree.

41. The apparatus according to claim 31, wherein the apparatus further comprises at least one linear encoder, wherein the encoder provides position feedback to at least 5 nm resolution.

42. The apparatus according to claim 31, wherein linear resolution for X, Y, and Z motions is to at least ±5 nm.

43. The apparatus according to claim 31, wherein linear resolution for X, Y, and Z motions is to at least ±5 nm for repeatability.

44. The apparatus according to claim 31, wherein the viewing assembly comprises a microscope having a travel length of at least 30 mm.

45. The apparatus according to claim 31, wherein the viewing assembly comprises a microscope having fluorescent detection.

46. The apparatus according to claim 31, wherein the array of pens comprises a two dimensional array of pens.

47. The apparatus according to claim 31, wherein the array of pens comprises a two dimensional array of pens comprising at least 55,000 pens.

48. The apparatus according to claim 31, wherein the multi-axis assembly is housed in an enclosure.

49. The apparatus according to claim 31, wherein the multi-axis assembly is mounted on an XY translation stage.

50. The apparatus according to claim 31, wherein the controller controls the motion of the multi-axis assembly.

51. A method comprising:
providing an array of pens comprising cantilevers, wherein the cantilevers comprise tips,
disposing material on the tips,
delivering material from the tips to a substrate, wherein the spatial position and orientation of the substrate is controlled by a multi-axis assembly providing motion in the X direction, the Y direction, the Z direction, a first tilt, and a second tilt orthogonal to the first tilt.

52. The method according to claim 51, wherein the tips are scanning probe microscopic tips.

53. The method according to claim 51, wherein the tips are atomic force microscopic tips.

54. The method according to claim 51, wherein the tips are solid nanoscale tips.

55. The method according to claim 51, wherein the tips comprise at least one opening.

56. The method according to claim 51, wherein the tips are actuated tips.

57. The method according to claim 51, wherein the tip position is controlled in the Z direction.

58. The method according to claim 51, wherein the array of pens comprises a two dimensional array of pens.

59. The method according to claim 51, wherein the material is a biological material.

60. The method according to claim 51, wherein the material is a nucleic acid, protein, or peptide material.

61. The method according to claim 51, wherein the multi-axis assembly provides five independent stages including an X-stage, a Y-stage, a Z-stage, a first tilt stage, and a second tilt stage which provides tilt orthogonal to the tilt of the first tilt stage.

62. The method according to claim 51, wherein the multi-axis assembly can move sufficiently so that delivery of material from the pens to the substrate can occur over a substrate surface area of at least 20 mm×20 mm.

63. The method according to claim 51, wherein the multi-axis assembly can move sufficiently so that delivery of material from the pens to the substrate can occur over a substrate surface area of at least 40 mm×40 mm.

64. The method according to claim 51, wherein the multi-axis assembly permits delivery of material from the pens to the substrate at a maximum travel speed of at most 20 cm/sec.

65. The method according to claim 51, wherein the multi-axis assembly is disposed on an XY translation stage.

66. The method according to claim 51, wherein the multi-axis assembly is disposed on a manually operatable XY translation stage.

67. The method according to claim 51, wherein the multi-axis assembly is part of an apparatus, and the apparatus further comprises an enclosure for the multi-axis assembly.

68. The method according to claim 51, wherein the multi-axis assembly comprises an opening facing the pens which is adapted for mounting a table assembly on which the substrate is disposed.

69. The according to claim 51, wherein the multi-axis assembly is part of an apparatus, and the apparatus further comprises a table assembly disposed on the multi-axis assembly for receiving the substrate.

70. The method according to claim 51, wherein the multi-axis assembly is part of an apparatus, and the apparatus further comprises an environmental chamber to surround the pens and substrate.

71. The method according to claim 51, wherein the multi-axis assembly is part of an apparatus, and the apparatus further comprises an environmental chamber to surround the pens and substrate, wherein the environmental chamber comprises an opening to facilitate viewing via a viewing assembly of the apparatus.

72. The method according to claim 51, wherein the multi-axis assembly is part of an apparatus, and the apparatus further comprises an environmental chamber to surround the pens and substrate, and the environmental chamber is adapted to control temperature, humidity, and gas composition.

73. The method according to claim 51, wherein the pens are part of a one dimensional array of pens.

74. The method according to claim 51, wherein the pens are part of a two dimensional array of pens comprising at least 10,000 pens.

75. The method according to claim 51, further comprising the step of viewing the substrate with a viewing assembly, wherein the viewing assembly comprises a microscope.

76. The method according to claim 51, further comprising the step of viewing the substrate with a viewing assembly, wherein the viewing assembly comprises a microscope adapted to permit fluorescent detection.

77. The method according to claim 51, further comprising the step of viewing the substrate with a viewing assembly, wherein the viewing assembly comprises a microscope adapted for viewing structures to a resolution of at least 400 nm.

78. The method according to claim 51, wherein the material comprises nucleic acid or protein material.

79. The method according to claim 51, wherein a controller is used which controls at least the movement of the multi-axis assembly.

80. The method according to claim 51, wherein a controller is used which comprises software to enable delivery of material in the form of dots or lines on the substrate.

81. An apparatus comprising:
at least one five-axis assembly comprising at least five integrated piezoelectric nanopositioning stages,
at least one pen assembly,
wherein the pen assembly and the multi-axis assembly are adapted for delivery of material from the pen assembly to a substrate which is positioned by the five-axis assembly,
at least one viewing assembly, and
at least one controller,
wherein the five-axis assembly comprises five independent stages including at least one X-stage, at least one Y-stage, at least one Z-stage, a first tilt stage, and a second tilt stage which provides tilt orthogonal to the tilt of the first tilt stage.

82. The apparatus according to claim 81, wherein the five-axis assembly comprises a table assembly onto which the substrate can be disposed.

83. The apparatus according to claim 81, wherein the viewing assembly comprises a microscope with a working distance of at least 30 mm.

84. The apparatus according to claim 81, further comprising at least one environmental chamber for surrounding the pen assembly and at least one microfluidic reservoir for the material to be delivered.

85. The apparatus according to claim 81, wherein the controller is adapted to control motion for the five-axis assembly.

86. The apparatus according to claim 81, wherein the pen assembly is adapted for direct-write nanolithography.

87. The apparatus according to claim 81, wherein the pen assembly comprises a two dimensional array of nanoscopic tips.

88. The apparatus according to claim 81, wherein the X-stage and the Y-stage each have a travel distance of at least 20 mm.

89. The apparatus according to claim 81, wherein the X-stage and the Y-stage each have a travel distance of at least 40 mm.

90. The apparatus according to claim 81, wherein the five-axis assembly in enclosed by a housing adapted to function with an environmental chamber for the pen assembly and a table assembly for the substrate.

91. A method comprising:
providing an apparatus according to claim 1,
delivering material from the pen assembly to the substrate.

92. The method according to claim 91, wherein the material comprises biological material.

93. The method according to claim 91, wherein the material comprises nucleic acid, protein, or peptide.

94. The method according to claim 91, wherein the material comprises oligonucleotide.

95. The method according to claim 91, wherein the material is delivered to the substrate in the form of dots or lines.

96. The method according to claim 91, wherein the pen assembly comprises an array of cantilevers comprising tips.

97. The method according to claim 91, wherein the pen assembly comprises an array of cantilevers comprising nanoscale tips.

98. The method according to claim 91, wherein the pen assembly comprises a two dimensional array of cantilevers comprising nanoscale tips.

99. The method according to claim 91, wherein the delivery is carried out over a distance of at least 5 mm.

100. The method according to claim 91, wherein the delivery is carried out over a distance of at least 20 mm.

101. An apparatus comprising:
at least one multi-axis assembly comprising at least five nanopositioning stages, wherein the multi-axis assembly comprises five independent stages including at least one X-stage, at least one Y-stage, at least one Z-stage, a first tilt stage, and a second tilt stage which provides tilt orthogonal to the tilt of the first tilt stage.

102. The apparatus according to claim 101, wherein the nanopositioning stages are piezoelectric, electrostatic, electromagnetic, or magnetostrictive nanopositioning stages.

103. The apparatus according to claim 101, wherein the nanopositioning stages comprise piezoelectric nanopositioning stages.

104. The apparatus according to claim 101, wherein the multi-axis assembly comprises a sixth nanopositioning stage.

105. The apparatus according to claim 101, wherein at least the X and the Y nanopositioning stages can travel linearly at least 20 mm.

106. The method according to claim 51, wherein the spatial position and orientation of the substrate is further controlled by software.

107. The method according to claim 91, wherein the delivering is controlled by software.

108. The method according to claim 91, wherein the delivering is controlled by software and a laser-based feedback system.

109. The apparatus according to claim 1, further comprising laser-based feedback system.

110. The apparatus according to claim 1, further comprising at least one atomic resolution scanner.

111. The apparatus according to claim 1, wherein the controller comprises software to enable definition of the substrate plane.
